(19) United States
(12) Patent Application Publication
(10) Pub. No.: US 2025/0078755 A1
(43) Pub. Date: Mar. 6, 2025

(54) DISPLAY PANEL AND DISPLAY APPARATUS

(71) Applicants: Wuhan Tianme Micro-Electronics Co., Ltd., Wuhan (CN); Wuhan Tianma Micro-Electronics Co., Lid. Shanghai Branch, Shanghai (CN)

(72) Inventors: Lin ZHANG, Wuhan (CN); Xian CHEN, Wuhan (CN)

(21) Appl. No.: 18/804,367

(22) Filed: Aug. 14, 2024

(30) Foreign Application Priority Data
Aug. 29, 2023 (CN) 202311102986.9

(51) Int. Cl. G09G 3/3233

(52) U.S. Cl. CPC G09G 3/3233; G09G 2300/0452; G09G 2300/0819; G09G 2300/0842; G09G 2300/0861; G09G 2320/0233; G09G 2320/0242; G09G 2320/045; G09G 2330/021

(57) ABSTRACT

The present disclosure includes a display panel and a display apparatus. The display panel includes a plurality of sub-pixels of different colors. The sub-pixel includes a pixel circuit and a light-emitting element, and the plurality of sub-pixels of different colors at least includes a first color sub-pixel and a second color sub-pixel. The display panel at least includes a first reference voltage signal line and a second reference voltage signal line. The first reference voltage signal line is electrically connected to an anode of a light-emitting element in the first color sub-pixel; and the second reference voltage signal line is electrically connected to an anode of a light-emitting element in the second color sub-pixel. A voltage value of a reference signal transmitted on the first reference voltage signal line is different from a voltage value of a reference signal transmitted on the second reference voltage signal line.

### CROSS-REFERENCE TO RELATED APPLICATION

The present disclosure claims the priority of Chinese Patent Application No. 202311102986.9, filed on Aug. 29, 2023, the content of which is incorporated herein by reference in its entirety.

### TECHNICAL FIELD

The present disclosure generally relates to the field of display technology and, more particularly, relates to a display panel and a display apparatus.

### BACKGROUND

With continuous development of display technology, display apparatuses are used widely, and requirements for display apparatuses are higher. Organic light-emitting diode (OLED) display apparatuses have advantages of self-illumination, wide viewing angle, high contrast, low power consumption, extremely high response speed, thinness, flexibility, low cost and the like. OLED display apparatuses, such as AMOLED (active matrix organic light-emitting diode) display apparatuses, have become popular due to advantages of self-illumination, wide viewing angle, high contrast, flexible display and the like.

For current OLED display panels, the problem of sub-pixel undesired display (e.g., undesired light leakage) often occurs. When a single-color picture is illuminated, other color sub-pixels near a sub-pixel may emit light slightly, which is called sub-pixel undesired display, thereby affecting display quality and user experience satisfaction.

Therefore, there is a need to provide a display panel and a display apparatus capable of avoiding the problem of undesired display between sub-pixels of different colors, which is beneficial for improving display effect and avoiding significant power consumption increase.

### SUMMARY

One aspect of the present disclosure provides a display panel. The display panel includes a plurality of sub-pixels of different colors, where a sub-pixel of the plurality of sub-pixels of different colors includes a pixel circuit and a light-emitting element which are electrically connected to each other, and the plurality of sub-pixels of different colors at least includes a first color sub-pixel and a second color sub-pixel. The display panel at least includes a first reference voltage signal line and a second reference voltage signal line; in the plurality of sub-pixels of different colors, the first reference voltage signal line is electrically connected to an anode of a light-emitting element in the first color sub-pixel; and the second reference voltage signal line is electrically connected to an anode of a light-emitting element in the second color sub-pixel; and a voltage value of a reference signal transmitted on the first reference voltage signal line is different from a voltage value of a reference signal transmitted on the second reference voltage signal line.

Another aspect of the present disclosure provides a display apparatus including a display panel. The display panel includes a plurality of sub-pixels of different colors, where a sub-pixel of the plurality of sub-pixels of different colors includes a pixel circuit and a light-emitting element which are electrically connected to each other, and the plurality of sub-pixels of different colors at least includes a first color sub-pixel and a second color sub-pixel. The display panel at least includes a first reference voltage signal line and a second reference voltage signal line; in the plurality of sub-pixels of different colors, the first reference voltage signal line is electrically connected to an anode of a light-emitting element in the first color sub-pixel; and the second reference voltage signal line is electrically connected to an anode of a light-emitting element in the second color sub-pixel; and a voltage value of a reference signal transmitted on the first reference voltage signal line is different from a voltage value of a reference signal transmitted on the second reference voltage signal line.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 illustrates a planar structural schematic of a display panel according to various embodiments of the present disclosure.

FIG. 2 illustrates a schematic of partial electrical connection at a J1 region in FIG. 1.

FIG. 3 illustrates a partial film-layer structure schematic at a J1 region in FIG. 1.

FIG. 4 illustrates another schematic of partial electrical connection at a J1 region in FIG. 1.

FIG. 5 illustrates another schematic of partial electrical connection at a J1 region in FIG. 1.

FIG. 6 illustrates a structural schematic of electrical connection of pixel circuits and light-emitting elements of a first color sub-pixel and a second color sub-pixel in a display panel according to various embodiments of the present disclosure.

FIG. 7 illustrates a circuit layout when a pixel circuit structure in FIG. 6 is formed on a substrate of a display panel.

FIG. 8 illustrates a structural schematic of a semiconductor layer in FIG. 7.

FIG. 9 illustrates a structural schematic of a first metal layer in FIG. 7.

FIG. 10 illustrates a structural schematic of a capacitor metal layer in FIG. 7.

FIG. 11 illustrates a structural schematic of a second metal layer in FIG. 7.

FIG. 12 illustrates another circuit layout when a pixel circuit structure in FIG. 6 is formed on a substrate of a display panel.

FIG. 13 illustrates a structural schematic of a semiconductor layer in FIG. 12.

FIG. 14 illustrates a structural schematic of a first metal layer in FIG. 12.

FIG. 15 illustrates a structural schematic of a capacitor metal layer in FIG. 12.

FIG. 16 illustrates a structural schematic of a second metal layer in FIG. 12.

FIG. 17 illustrates another circuit layout when a pixel circuit structure in FIG. 6 is formed on a substrate of a display panel.

FIG. 18 illustrates a structural schematic of a semiconductor layer in FIG. 17.

FIG. 19 illustrates a structural schematic of a first metal layer in FIG. 17.

FIG. 20 illustrates a structural schematic of a capacitor metal layer in FIG. 17.

FIG. 21 illustrates a structural schematic of a second metal layer in FIG. 17.

FIG. 22 illustrates another circuit layout when a pixel circuit structure in FIG. 6 is formed on a substrate of a display panel.

FIG. 23 illustrates another structural schematic of electrical connection of pixel circuits and light-emitting elements of a first color sub-pixel and a second color sub-pixel in a display panel according to various embodiments of the present disclosure.

FIG. 24 illustrates a circuit layout when a pixel circuit structure in FIG. 23 is formed on a substrate of a display panel.

FIG. 25 illustrates a structural schematic of a semiconductor layer in FIG. 24.

FIG. 26 illustrates a structural schematic of a first metal layer in FIG. 24.

FIG. 27 illustrates a structural schematic of a capacitor metal layer in FIG. 24.

FIG. 28 illustrates a structural schematic of a second metal layer in FIG. 24.

FIG. 29 illustrates another structural schematic of electrical connection of pixel circuits and light-emitting elements of a first color sub-pixel and a second color sub-pixel in a display panel according to various embodiments of the present disclosure.

FIG. 30 illustrates a circuit layout when a pixel circuit structure in FIG. 29 is formed on a substrate of a display panel.

FIG. 31 illustrates a structural schematic of a semiconductor layer in FIG. 30.

FIG. 32 illustrates a structural schematic of a first metal layer in FIG. 30.

FIG. 33 illustrates a structural schematic of a capacitor metal layer in FIG. 30.

FIG. 34 illustrates a structural schematic of a second metal layer in FIG. 30.

FIG. 35 illustrates another structural schematic of electrical connection of pixel circuits and light-emitting elements of a first color sub-pixel and a second color sub-pixel in a display panel according to various embodiments of the present disclosure.

FIG. 36 illustrates a circuit layout when a pixel circuit structure in FIG. 35 is formed on a substrate of a display panel.

FIG. 37 illustrates a structural schematic of a semiconductor layer in FIG. 36.

FIG. 38 illustrates a structural schematic of a first metal layer in FIG. 36.

FIG. 39 illustrates a structural schematic of a capacitor metal layer in FIG. 36.

FIG. 40 illustrates a structural schematic of a second metal layer in FIG. 36.

FIG. 41 illustrates another circuit layout when a pixel circuit structure in FIG. 35 is formed on a substrate of a display panel.

FIG. 42 illustrates another structural schematic of electrical connection of pixel circuits and light-emitting elements of a first color sub-pixel, a second color sub-pixel and a third color sub-pixel in a display panel according to various embodiments of the present disclosure.

FIG. 43 illustrates a circuit layout when a pixel circuit structure in FIG. 42 is formed on a substrate of a display panel.

FIG. 44 illustrates another structural schematic of electrical connection of pixel circuits and light-emitting elements of a first color sub-pixel and a second color sub-pixel in a display panel according to various embodiments of the present disclosure.

FIG. 45 illustrates a circuit layout when a pixel circuit structure in FIG. 44 is formed on a substrate of a display panel.

FIG. 46 illustrates a structural schematic of a polysilicon semiconductor layer in FIG. 44.

FIG. 47 illustrates a structural schematic of a bottom metal layer in FIG. 44.

FIG. 48 illustrates a structural schematic of a first metal layer in FIG. 44.

FIG. 49 illustrates a structural schematic of a capacitor metal layer in FIG. 44.

FIG. 50 illustrates a structural schematic of an indium gallium zinc oxide semiconductor layer in FIG. 44.

FIG. 51 illustrates a structural schematic of a gate metal layer in FIG. 44.

FIG. 52 illustrates a structural schematic of a second metal layer in FIG. 44.

FIG. 53 illustrates a structural schematic of a third metal layer in FIG. 44.

FIG. 54 illustrates a planar structural schematic of a display apparatus according to various embodiments of the present disclosure.

### DETAILED DESCRIPTION

Various exemplary embodiments of the present disclosure are described in detail with reference to accompanying drawings. It should be noted that unless stated otherwise, relative arrangement of assemblies and steps, numerical expressions and values described in those embodiments may not limit the scope of the present disclosure.

Following description of at least one exemplary embodiment may be merely illustrative and may not be configured to limit the present disclosure and its application or use.

The technologies, methods and apparatuses known to those skilled in the art may not be discussed in detail, but where appropriate, the technologies, methods and apparatuses should be considered as a part of the present disclosure.

In all examples shown and discussed herein, any specific value should be interpreted as merely exemplary, rather than as a limitation. Therefore, other examples in exemplary embodiment may have different values.

It is apparent to those skilled in the art that various modifications and variations may be made in the present disclosure without departing from the spirit or scope of the present disclosure. Therefore, the present disclosure is intended to cover modifications and variations of the present disclosure falling within the scope of corresponding claims (technical solutions to be protected) and their equivalents. It should be noted that, implementation manners provided in embodiment of the present disclosure may be combined with each other if there is no contradiction.

It should be noted that similar reference numerals and letters are configured to indicate similar items in following drawings. Therefore, once an item is defined in one drawing, it does not need to be further discussed in subsequent drawings.

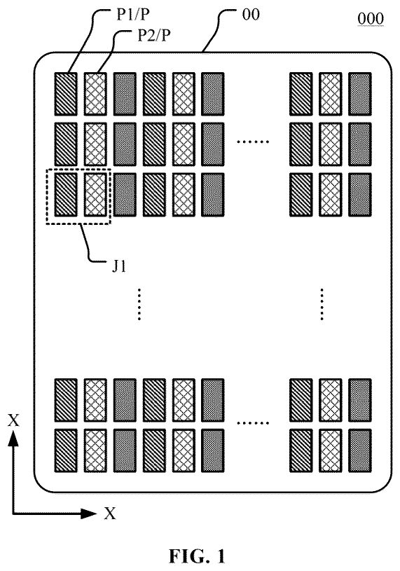

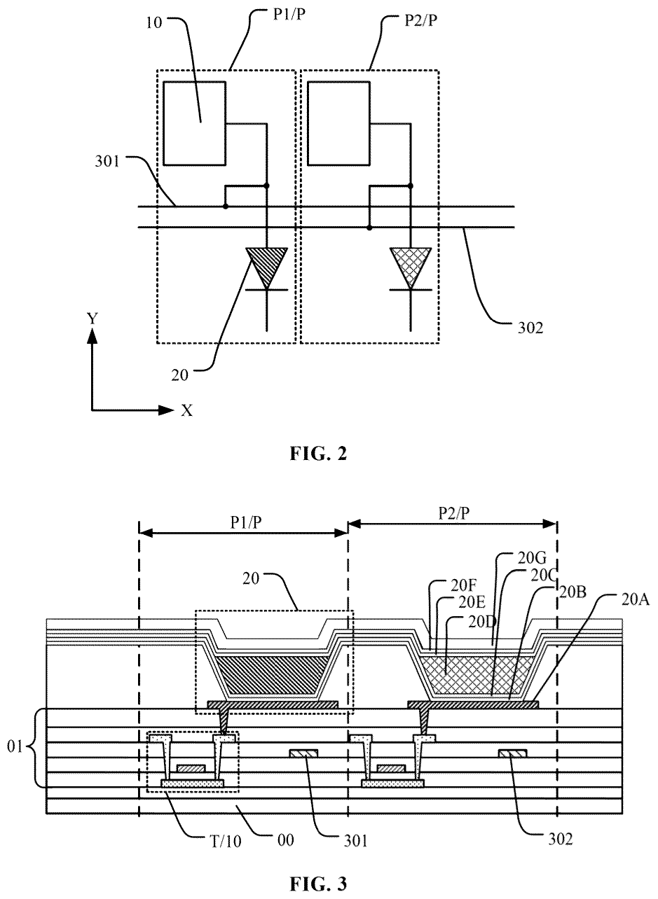

Referring to FIGS. 1-2, FIG. 1 illustrates a planar structural schematic of a display panel according to various embodiments of the present disclosure; and FIG. 2 illustrates a schematic of partial electrical connection at a J1 region in FIG. 1. In one embodiment, a display panel 000 may include a plurality of sub-pixels P with different colors; the sub-pixel P may include a pixel circuit 10 and a light-emitting element 20 which are electrically connected to each other; and the plurality of sub-pixels P with different colors may at least include the first color sub-pixel P1 and the second color sub-pixel P2.

The display panel 000 may at least include the first reference voltage signal line 301 and the second reference voltage signal line 302.

In the plurality of sub-pixels P, the first reference voltage signal line 301 may be electrically connected to the anode of the light-emitting element 20 in the first color sub-pixel P1, and the second reference voltage signal line 302 may be electrically connected to the anode of the light-emitting element 20 in the second color sub-pixel P2.

The voltage value of the reference signal transmitted on the first reference voltage signal line 301 may be different from the voltage value of the reference signal transmitted on the second reference voltage signal line 302.

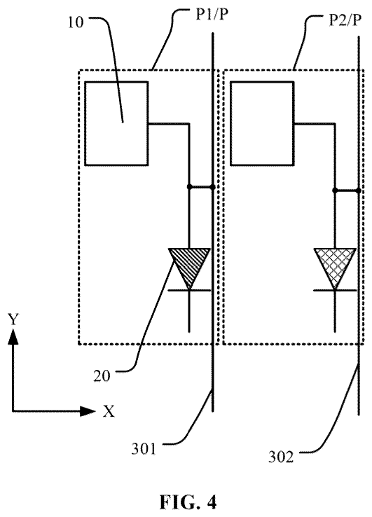

For example, the display panel 100 provided in one embodiment may be an organic light-emitting diode display panel and include the plurality of sub-pixels P with different colors. It should be noted that in FIG. 1 of one embodiment, in order to distinguish the sub-pixels P of different colors, different filling patterns are used to indicate the sub-pixels P of different colors; and a same filling pattern is used to indicate the sub-pixels P of same color, which may not be described in detail hereinafter. Each sub-pixel P may drive the light-emitting element 20 to achieve light-emitting display function through the pixel circuit 10 included in each sub-pixel P. It may be understood that FIG. 2 of one embodiment only illustrates the pixel circuit 10 as a block diagram. During an implementation, the structure of the pixel circuit 10 may be a circuit structure of multiple transistors T and capacitors which are electrically connected to each other, which may not be limited in one embodiment. The light-emitting element 20 may be an organic light-emitting diode. The light-emitting element 20 may be a multi-layer structure. Referring to FIG. 3, FIG. 3 illustrates a partial film-layer structure schematic at the J1 region in FIG. 1. The display panel 000 may include a substrate 00 and a drive circuit layer 01 on one side of the substrate 00. The drive circuit layer 01 may be configured to form the pixel circuit 10 of each sub-pixel P. The side of the drive circuit layer 01 away from the substrate 00 may be disposed with a multi-layer structure of the light-emitting element 20. The light-emitting element 20 may include an anode 20A, a hole injection layer 20B, a hole transport layer 20C, an organic material light-emitting layer 20D, an electron transport layer 20E, an electron injection layer 20F and a cathode 20G. It may be understood that in some other optional embodiments, the anode 20A and the cathode 20G may also be understood as structures of the display panel 000 other than the light-emitting element 20. During display, the light-emitting element 20 may be driven by an electric field to cause light-emitting through carrier injection and recombination, and the display principle is described hereinafter. The anode 20A and the cathode 20G in each sub-pixel P may form the electric field driven by a certain voltage; electrons and holes may be injected from the cathode 20G and the anode 20A into the electron injection layer 20F and the hole injection layer 20B respectively; electrons may be transported to the electron transport layer 20E through the electron injection layer 20F, and holes may be transported to the hole transport layer 20C through the hole injection layer 20B; and the electrons and holes may migrate to the organic material light-emitting layer 20D through the electron transport layer 20E and the hole transport layer 20C respectively, and the electrons and holes may meet in the organic material light-emitting layer 20D to form excitons and excite the light-emitting molecules which then undergo radiation relaxation and emit visible light.

During the formation process of the display panel 000, in order to save costs and reduce process steps, a same mask may be used to simultaneously evaporate the light-emitting elements 20 of the sub-pixels P of different colors. In addition to that the anodes 20A and the light-emitting layers 20D are independent structures of sub-pixels P of different colors, remaining layers including the hole injection layer 20B, the hole transport layer 20C, the electron transport layer 20E, and the electron injection layer 20F, at least one layer may be shared by the plurality of sub-pixels P of different colors; and even the hole injection layer 20B, the hole transport layer 20C, the electron transport layer 20E, and the electron injection layer 20F may be all shared by the plurality of sub-pixels P. That is, at least one common film layer may be in the light-emitting elements 20 of sub-pixels P of different colors.

Currently, when the display panel 000 drives the light-emitting element 20 to emit light, since the common film layer has a certain carrier migration capability, corresponding lateral leakage current may cause other sub-pixels P to have undesired display. For example, the plurality of sub-pixels P of different colors in the display panel 000 include at least the first-color sub-pixel P1 and the second-color sub-pixel P2. There are differences in the turn-on voltages of the light-emitting elements 20 of different emitting colors included in the sub-pixels P of different colors. Therefore, under low grayscale visual effect, if the light-emitting element 20 of the first color sub-pixel P1 or the light-emitting element 20 of the second color sub-pixel P2 is turned on to form a monochrome picture, the driving current required to turn on one light-emitting element 20 may easily leak through the common film layer of the display panel 000 laterally (along the direction parallel to the plane of the substrate 00) to another light-emitting element of an adjacent sub-pixel of another color due to the turn-on voltages of these two light-emitting elements 20 are different, which may cause slight light-emitting. That is, when the light-emitting element of the sub-pixel of one color is turned on to achieve the monochrome picture, the light-emitting element of the sub-pixel of another color may have a problem of undesired display. In the existing technology, when forming the common film layer, the material with relatively small carrier mobility may be used. However, such design may need to increase the voltage at two ends of the anode and the cathode to ensure that the brightness of the light-emitting element meets requirements, which may easily increase the driving power consumption of the panel and may be not beneficial for energy-saving design. However, if the material with relatively large carrier mobility is still used to form the common film layer, although there is no need to increase the voltage at two ends of the anode and the cathode to avoid power consumption increase, the lateral migration ability of carriers may be increased, which may lead to sub-pixel undesired display and cause the display effect to decrease.

In order to solve above-mentioned problem, in one embodiment, the display panel 000 may be configured to at least include the first reference voltage signal line 301 and the second reference voltage signal line 302; in the plurality of sub-pixels P, the first reference voltage signal line 301 may be electrically connected to the anode of the light-emitting element 20 in the first color sub-pixel P1; the reference signal transmitted on the first reference voltage signal line 301 may be configured to reset the anode of the light-emitting element 20 in the first color sub-pixel P1; the second reference voltage signal line 302 may be electrically connected to the anode of the light-emitting element 20 in the second color sub-pixel P2; and the reference signal transmitted on the second reference voltage signal line 302 may be configured to reset the anode of the light-emitting element 20 in the second color sub-pixel P2. That is, the light-emitting elements 20 of two sub-pixels P of different colors may use different reference voltage signal lines to perform reset control independently. Moreover, in one embodiment, it also configures that the voltage value of the reference signal transmitted on the first reference voltage signal line 301 may be different from the voltage value of the reference signal transmitted on the second reference voltage signal line 302. That is, when the turn-on voltage of the light-emitting element 20 of the first color sub-pixel P1 is different from the turn-on voltage of the light-emitting element 20 of the second color sub-pixel P2, it configures that the voltage value of the reference signal transmitted on the first reference voltage signal line 301 for resetting the anode of the light-emitting element 20 of the first color sub-pixel P1 may be different from the voltage value of the reference signal transmitted on the second reference voltage signal line 302 for resetting the anode of the light-emitting element 20 of the second color sub-pixel P2. When the light-emitting element 20 in the display panel 000 emits light, the light-emitting element 20 may be charged from an initial reset voltage to a target turn-on voltage. As long as a cross-voltage value is satisfied, the light-emitting element 20 of the sub-pixel P may be turned on automatically. In one embodiment, the anode reset signal values of the light-emitting element 20 of the first color sub-pixel P1 and the light-emitting element 20 of the second color sub-pixel P2 with different turn-on voltages may be configured to be different. When the light-emitting element 20 of the second color sub-pixel P2 or the light-emitting element 20 of the first color sub-pixel P1 is turned on to achieve the monochrome picture, the sub-pixel of another color adjacent to the turned-on sub-pixel may be configured to be difficult to reach the cross-voltage value. It may also be understood that the light-emitting element 20 may have a charging process in an early stage of turn-on; the voltage of initial reference signal transmitted from the reference voltage signal line may be charged until reaching a target value; and the light-emitting element 20 may emit light only when reaching such target value, that is, the turn-on voltage value. Therefore, in one embodiment, if the turn-on voltage of the light-emitting element 20 of the first color sub-pixel P1 is different from the turn-on voltage of the light-emitting element 20 of the second color sub-pixel P2, the voltage value of the reference signal transmitted on the first reference voltage signal line 301 for resetting the anode of the first color sub-pixel P1 light-emitting element 20 may be different from the voltage value of the reference signal transmitted on the second reference voltage signal line 302 for resetting the anode of the second color sub-pixel P2 light-emitting element 20. When one sub-pixel in the second color sub-pixel P2 and the first color sub-pixel P1 is turned on to achieve the monochrome picture, even if another sub-pixel in the second color sub-pixel P2 and the first color sub-pixel P1 is affected by the common film layer to charge the anode of corresponding light-emitting element 20, longer charging time and more charges may be needed to reach the target threshold voltage to turn on the sub-pixel; and the light-emitting element of another sub-pixel in the second color sub-pixel P2 and the first color sub-pixel P1 may be less likely to be turned on. Therefore, the undesired display problem of adjacent sub-pixels of different colors when the monochrome picture is turned on may be effectively reduced, which may be beneficial for improving the display quality. Furthermore, the material with higher carrier mobility may be used to form the common film layer in the display panel, and the power consumption of the display panel 000 may not increase significantly.

FIG. 1 of one embodiment only takes the arrangement of the plurality of sub-pixels P array as an example for illustration. During an implementation, the arrangement of the sub-pixels P in the display panel 000 may also have other arrangement manners, which may not be limited in one embodiment.

It may be understood that the structure of the display panel 000 may be exemplarily illustrated in drawings. During an implementation, the structure of the display panel may include but may not be limited to above structure and may also include other structures capable of realizing the display function, which may not be described in detail herein and may be understood with reference to the structure of the organic light-emitting diode display panel in the exiting technology.

In some optional embodiments, referring to FIGS. 1-2, the turn-on voltage of the light-emitting element 20 in the first color sub-pixel P1 may be less than the turn-on voltage of the light-emitting element 20 in the second color sub-pixel P2; and the voltage value of the reference signal transmitted on the first reference voltage signal line 301 may be less than the voltage value of the reference signal transmitted on the second reference voltage signal line 302.

In one embodiment, it describes that if the turn-on voltage of the light-emitting element 20 of the first color sub-pixel P1 is less than the turn-on voltage of the light-emitting element 20 of the second color sub-pixel P2, under low grayscale visual effect, the driving current that drives the light-emitting element 20 of the second color sub-pixel P2 to be turned on may easily leak laterally (along the direction in parallel with the plane of substrate 00) through the common film layer of the display panel 000 to surrounding light-emitting element 20 of the first color sub-pixel P1 if the monochrome picture of the second color sub-pixel P2 is turned on. In addition, since the turn-on voltage of the light-emitting element 20 of the first color sub-pixel P1 is less than the turn-on voltage of the light-emitting element 20 of the second color sub-pixel P2, even small leakage current may likely make that the voltage to be close to the turn-on voltage of the light-emitting element 20 of the first color sub-pixel P1. The first color sub-pixel P1 adjacent to the second color sub-pixel P2 may emit light slightly. That is, when the light-emitting element 20 of the second-color sub-pixel P2 is turned on to realize the monochrome picture, the light-emitting element 20 of the first-color sub-pixel P1 may have undesired display.

Therefore, in one embodiment, it configures that the display panel 000 may at least include the first reference voltage signal line 301 and the second reference voltage signal line 302; and the voltage value of the reference signal transmitted on the first reference voltage signal line 301 may be less than the voltage value of the reference signal transmitted on the second reference voltage signal line 302. That is, if the turn-on voltage of the light-emitting element 20 of the first color sub-pixel P1 is less than the turn-on voltage of the light-emitting element 20 of the second color sub-pixel P2, the voltage value of the reference signal transmitted on the first reference voltage signal line 301 for resetting the anode of the light-emitting element 20 of the first color sub-pixel P1 may be configured to be less than the voltage value of the reference signal transmitted on the second reference voltage signal line 302 for resetting the anode of the light-emitting element 20 of the second color sub-pixel P2. When the light-emitting element 20 in the display panel 000 emits light, the light-emitting element 20 may be charged from the initial reset voltage to the target turn-on voltage. As long as the cross-voltage value is satisfied, the light-emitting element 20 of the sub-pixel P may be turned on automatically. In one embodiment, the reset signal value of the anode of the light-emitting element 20 of the first color sub-pixel P1 with small turn-on voltage may be pulled down. When the light-emitting element 20 of the second color sub-pixel P2 is turned on to realize the monochrome picture, the first color sub-pixel P1 may be less likely to reach the cross-voltage value than the second color sub-pixel P2. It may also be understood that the light-emitting element 20 may be a charging process in the early stage of turning on. The potential may be charged from the voltage of the initial reference signal transmitted by the reference voltage signal line until reaching a target value; and the light may only be emitted when reaching such target value, that is, the turn-on voltage value. Therefore, in one embodiment, it configures that if the turn-on voltage of the light-emitting element 20 of the first color sub-pixel P1 is less than the turn-on voltage of the light-emitting element 20 of the second color sub-pixel P2, the voltage value of the reference signal transmitted on the first reference voltage signal line 301 for resetting the anode of the first color sub-pixel P1 light-emitting element 20 may be less than the voltage value of the reference signal transmitted on the second reference voltage signal line 302 for resetting the anode of the second color sub-pixel P2 light-emitting element 20. That is, the voltage value of the initial reference signal of the first color sub-pixel P1 light-emitting element 20 may be relatively low. When the second color sub-pixel P2 is turned on to achieve the monochrome picture, even if the first color sub-pixel P1 is affected by the common film layer to charge the anode of corresponding light-emitting element 20, longer charging time and more charges may be needed to reach the target turn-on voltage of the first color sub-pixel P1; and the light-emitting element 20 of the first color sub-pixel P1 may be less likely to be turned on. Therefore, the undesired display problem of the first color sub-pixel P1 when the monochrome picture is turned on may be effectively reduced, which may be beneficial for improving the display quality. Furthermore, the material with higher carrier mobility may be used to form the common film layer in the display panel, and the power consumption of the display panel 000 may not increase significantly.

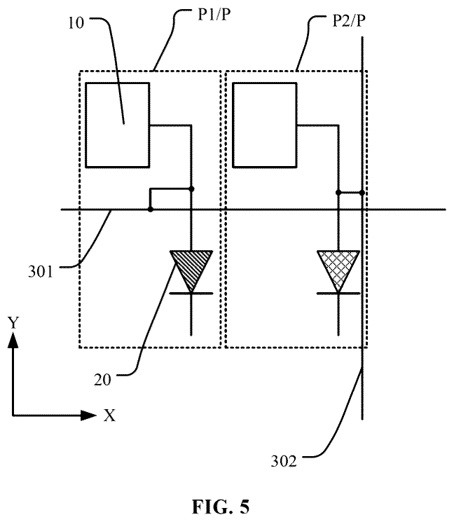

Optionally, as shown in FIGS. 1 and 2, the extension direction of the first reference voltage signal line 301 and the extension direction of the second reference voltage signal line 302 may be same. As shown in FIG. 1, the extension direction of the first reference voltage signal line 301 and the extension direction of the second reference voltage signal line 302 may be both the first direction X. Or as shown in FIGS. 1 and 4, FIG. 4 illustrates another schematic of partial electrical connection at the J1 region in FIG. 1; and the extension direction of the first reference voltage signal line 301 and the extension direction of the second reference voltage signal line 302 may be both the second direction Y, which may not be limited in one embodiment.

As shown in FIGS. 1 and 5, FIG. 5 illustrates another schematic of partial electrical connection at the J1 region in FIG. 1. The first reference voltage signal line 301 may extend along the first direction X, and the second reference voltage signal line 302 may extend along the second direction Y, where the first direction X may intersect the second direction Y. In FIGS. 1 and 5, the first direction X and the second direction Y are perpendicular to each other as an example for illustration. In one embodiment, it configures that the first reference voltage signal line 301 may extend along the first direction X, and the second reference voltage signal line 302 may extend along the second direction Y. That is, the extension direction of the first reference voltage signal line 301 may intersect the extension direction of the second reference voltage signal line 302; and the extension direction of the first reference voltage signal line 301 and the extension direction of the second reference voltage signal line 302 may be different, which may be beneficial for reducing the width at the second direction Y occupied by the plurality of reference voltage signal lines extending along the first direction X, saving wiring space along a same direction (such as the first direction X or the second direction Y), and further reducing spatial wiring difficulty and improving process efficiency.

Optionally, in one embodiment, when the first color sub-pixel P1 includes either a red sub-pixel or a green sub-pixel, the second color sub-pixel P2 may include a blue sub-pixel. When the light-emitting element 20 is an organic light-emitting diode, the turn-on voltage of the red light-emitting element may be lower than the turn-on voltage of the blue light-emitting element, and the turn-on voltage of the green light-emitting element may be lower than the turn-on voltage of the blue light-emitting element. Therefore, when the blue light-emitting element is turned on, the turn-on voltage of the blue light-emitting element may be greater than the turn-on voltages of both the red light-emitting element and the green light-emitting element, such that under the blue picture, red and/or green undesired display may appear, which may affect the display quality of the display picture. In one embodiment, when the first color sub-pixel P1 is the red sub-pixel or the green sub-pixel with a low turn-on voltage, and the second color sub-pixel P2 is the blue sub-pixel with a high turn-on voltage, the voltage value of the initial reference signal of the light-emitting element 20 of the first color sub-pixel P1 may be pulled down. Even if the first color sub-pixel P1 is affected by the common film layer to charge the anode of the light-emitting element 20 when the second color sub-pixel P2 is turned on to achieve the blue picture. longer charging time and more charges may be needed to reach the target turn-on voltage of the first color sub-pixel P1; and the light-emitting element 20 of the first color sub-pixel P1 may be less likely to be turned on. Therefore, the undesired display problem of the first color sub-pixel P1 of red or green color when the blue picture of the second color sub-pixel P2 is turned on may be effectively reduced, which may be beneficial for improving the display quality.

Optionally, referring to FIGS. 1-6, FIG. 6 illustrates a structural schematic of electrical connection of pixel circuits and light-emitting elements of the first color sub-pixel and the second color sub-pixel in the display panel according to various embodiments of the present disclosure. In one embodiment, the display panel 000 may include the plurality of sub-pixels P; the sub-pixel P may include the pixel circuit 10 and the light-emitting element 20 which are electrically connected to each other; and the light-emitting element 20 may be an organic light-emitting diode. The pixel circuit 10 may include a first transistor T1, a second transistor T2, a driving transistor DT, a fourth transistor T4, a fifth transistor T5, a sixth transistor T6, a seventh transistor T7 and a storage capacitor Cst. The gate electrode of the driving transistor DT may be connected to the first electrode of the fifth transistor T5; the second electrode of the fifth transistor T5 may be connected to the third reference voltage signal line 303 (the reset signal for the gate electrode of the driving transistor DT may be provided by another reference voltage line); and the gate electrode of the fifth transistor T5 may be connected to a first scan signal line Scan1.

The first electrode of the driving transistor DT may be connected to the first electrode of the first transistor T1, the second electrode of the first transistor T1 may be connected to a first power signal line PVDD, the first power signal line PVDD may provide a first power signal Vpvdd, and the gate electrode of the first transistor T1 may be connected to a light-emitting control signal line EM.

The first electrode of the driving transistor DT may be also connected to the first electrode of the second transistor T2, the second electrode of the second transistor T2 may be connected to a data line S, and the gate electrode of the second transistor T2 may be connected to a second scan signal line Scan2.

The second electrode of the driving transistor DT may be connected to the first electrode of the sixth transistor T6, the second electrode of the sixth transistor T6 may be connected to the anode of the light-emitting element 20, the cathode of the light-emitting element 20 may be connected to the second power signal line PVEE, the second power signal line PVEE may provide the second power signal Vpvee, and the gate electrode of the sixth transistor T6 may be also connected to the light-emitting control signal line EM. That is, the gate electrode of the first transistor T1 and the gate electrode of the sixth transistor T6 may share a same light-emitting control signal line EM. When the gate electrode of the first transistor T1 and the gate electrode of the sixth transistor T6 jointly respond to a light-emitting control signal provided by the light-emitting control signal line EM, the first transistor T1 and the sixth transistor T6 may be in a conduction state.

The first electrode of the seventh transistor T7 of the first color sub-pixel P1 may be connected to the first reference voltage signal line 301, the second electrode of the seventh transistor T7 of the first color sub-pixel P1 may be connected to the anode of the light-emitting element 20 of the first color sub-pixel P1, and the gate electrode of the seventh transistor T7 of the first color sub-pixel P1 may be connected to the first scan signal line Scan1. That is, when the gate electrode of the fifth transistor T5 and the gate electrode of the seventh transistor T7 of the first color sub-pixel P1 jointly respond to the first scan signal Scan1, the fifth transistor T5 and the seventh transistor T7 may be in a conduction state. Optionally, the third reference voltage signal line 303 and the first reference voltage signal line 301 may provide different reset voltage signals; or the third reference voltage signal line 303 and the first reference voltage signal line 301 may provide a same reset voltage signal. In drawings of one embodiment, the third reference voltage signal line 303 and the first reference voltage signal line 301 may provide different reset voltage signals and may be different signal lines, which may be taken only as an example for illustration.

The first electrode of the seventh transistor T7 of the second color sub-pixel P2 may be connected to the second reference voltage signal line 302, the second electrode of the seventh transistor T7 of the second color sub-pixel P2 may be connected to the anode of the light-emitting element 20 of the second color sub-pixel P2, and the gate electrode of the seventh transistor T7 of the second color sub-pixel P2 may be connected to the first scan signal line Scan1. That is, when the gate electrode of the fifth transistor T5 and the gate electrode of the seventh transistor T7 of the second color sub-pixel P2 jointly respond to the first scan signal Scan1, the fifth transistor T5 and the seventh transistor T7 may be in a conduction state. Optionally, the third reference voltage signal line 303 and the second reference voltage signal line 302 may provide different reset voltage signals; or the third reference voltage signal line 303 and the second reference voltage signal line 302 may provide a same reset voltage signal. In drawings of one embodiment, the third reference voltage signal line 303 and the second reference voltage signal line 302 may provide different reset voltage signals and may be different signal lines, which may be taken only as an example for illustration.

The first electrode of the fourth transistor T4 may be connected to the gate electrode of the driving transistor DT, the second electrode of the fourth transistor T4 may be connected to the second electrode of the driving transistor DT, and the gate electrode of the fourth transistor T4 may be connected to the second scan signal line Scan2. That is, when the gate electrode of the fourth transistor T4 and the gate electrode of the second transistor T2 are jointly connected to the second scan signal line Scan2, and when the gate electrode of the fourth transistor T4 and the gate electrode of the second transistor T2 jointly respond to the scan drive signal provided by the second scan signal line Scan2, the fourth transistor T4 and the second transistor T2 may be in a conduction state.

One electrode of the storage capacitor Cst may be connected to the first power supply signal line PVDD, and another electrode of the storage capacitor Cst may be connected to the gate electrode of the driving transistor DT. The storage capacitor Cst may be configured to stabilize the potential of the gate electrode of the driving transistor DT, which may be beneficial for keeping the driving transistor DT to be in conduction.

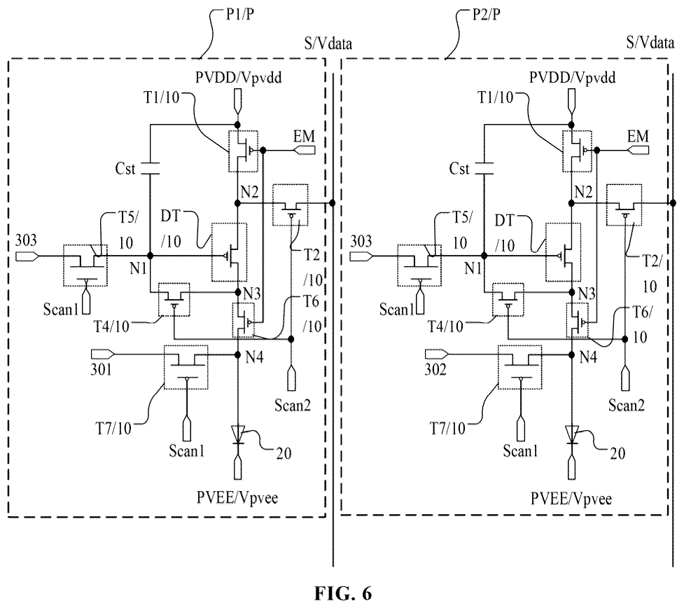

In one embodiment, it describes that the pixel circuit 10 in the display panel 000 may include a circuit connection structure. The pixel circuit 10 may include a plurality of transistors and a storage capacitor Cst, where one transistor may be the driving transistor DT, and remaining transistors may be switching transistors. The structure that the pixel circuit 10 and the light-emitting element 20 are electrically connected to each other may be taken as an example, as shown in FIG. 6 of one embodiment. The first node N1 is at the position of the gate electrode of the driving transistor DT, the second node N2 is at the position of the first electrode of the driving transistor DT, the third node N3 is at the position of the second pole of the driving transistor DT, and the fourth node N4 is at the anode of the light-emitting element 02. The working principle of such sub-pixel P is described hereinafter.

At an initial reset stage, the fifth transistor T5 and the seventh transistor T7 may be turned on to be in conduction, and other transistors may be turned off to be in disconnection. The potential of the first node N1 may be the first reset signal provided by the third reference voltage signal line 303; the potential of the fourth node N4 of the first color sub-pixel P1 may be the voltage value of the reference signal provided by the first reference voltage signal line 301; and the potential of the fourth node N4 of the second color sub-pixel P2 may be the voltage value of the reference signal provided by the second reference voltage signal line 302, thereby completing the reset of the gate electrode of the driving transistor DT and the anode of the light-emitting element 02.

At a data write and threshold capture stage, the second transistor T2, the fourth transistor T4, and the driving transistor DT may be turned on to be in conduction, and other transistors may be turned off to be in disconnection. The potential of the second node N2 may be the data voltage signal Vdata provided by the data line S, the potential of the first node N1 and the third node N3 may be Vdata−|Vth|, where Vth is the threshold voltage of the driving transistor DT.

At a light-emitting stage, the first transistor T1, the sixth transistor T6, and the driving transistor DT may be turned on to be in conduction, and other transistors may be turned off to be in disconnection. The first power signal Vpvdd provided by the first power signal line PVDD may be transmitted to the driving transistor DT, and the driving transistor DT may generate a driving current to drive the light-emitting element 20 to emit light. The potential of the second node N2 may be the first power signal Vpvdd, the potential of the first node N1 may be Vdata−|Vth|, the potential of the third node N3 may be Vpvee+Voled, where Vpvee may be the second power signal provided by the second power signal line PVEE which is a negative potential, and Voled may be a corresponding voltage on the light-emitting element 20. Therefore, the light-emitting current Id=k(Vgs−|Vth|)2=k(Vpvdd−Vdata−|Vth|)2, where the constant k is related to the performance of the driving transistor DT itself.

In one embodiment, it configures that the voltage value of the reference signal transmitted on the first reference voltage signal line 301 may be less than the voltage value of the reference signal transmitted on the second reference voltage signal line 302. That is, the reset signal of the anode of the light-emitting element 20 of the first color sub-pixel P1 may be different from the reset signal of the anode of the light-emitting element 20 of the second color sub-pixel P2, which may be transmitted through different reference voltage signal lines. The anode reset signal value of the light-emitting element 20 of the first color sub-pixel P1 with small turn-on voltage may be pulled down to a value less than the anode reset signal value of the light-emitting element 20 of the second color sub-pixel P2, such that the voltage value of the initial reference signal of the first color sub-pixel P1 light-emitting element 20 may be relatively low. Even if the first color sub-pixel P1 is affected by the common film layer to charge the anode of the light-emitting element 20 when the second color sub-pixel P2 is turned on to achieve the monochrome picture, longer charging time and more charges may be needed to reach the target turn-on voltage for the first color sub-pixel P1; and the light-emitting element 20 of the first color sub-pixel P1 may be less likely to be turned on. Therefore, the undesired display problem of the first color sub-pixel P1 when the monochrome picture of the second color sub-pixel P2 is turned on may be effectively reduced, which may be beneficial for improving the display quality. In addition, the power consumption of the display panel 000 may not increase significantly.

It may be understood that in one embodiment, it only exemplarily illustrates that the sub-pixel P may include the electrical connection structure of the pixel circuit 10 and the light-emitting element 20 when the display panel 000 is an organic light-emitting diode display panel. During an implementation, the electrical connection structure of the pixel circuit 10 and the light-emitting element 20 included in the sub-pixel P may include, but may not be limited to, above-mentioned structure, and may also be other implementation structures which may not be limited in one embodiment and refer to the structure of the pixel circuit in the existing technology.

When above-mentioned exemplary pixel circuit 10 is formed on the substrate 00 included in the display panel 000, the pixel circuit 10 may be exemplarily shown as the circuit layout of following embodiments. The film-layer structure of the display panel 000 may at least include a semiconductor layer POLY, a first metal layer M1, a capacitive metal layer Mc, and a second metal layer M2, as shown in the circuit layout of following embodiments. It may be understood that the pixel circuit including three sub-pixels may be taken as an example for illustration. Three sub-pixels may include two first color sub-pixels P1 and one second color sub-pixel P2. That is, two first color sub-pixels P1 may be the red sub-pixel and the green sub-pixel; and one second color sub-pixel P2 may be the blue sub-pixel. The active portion of the transistor in the pixel circuit may be at the semiconductor layer POLY; the gate electrode of the transistor in the pixel circuit may be at the first metal layer M1; and the first scan signal line Scan1, the second scan signal line Scan2, and the light-emitting control signal line EM may be at the first metal layer M1. Two electrodes of the storage capacitor Cst included in the pixel circuit may be respectively at the first metal layer M1 and the capacitor metal layer Mc; the source and drain electrodes of the transistors in the pixel circuit may be at the second metal layer M2; and the data line S and the first power signal line PVDD may be at the second metal layer M2. It may be understood that the film layer structure of the display panel 000 may also include other metal layers, for example, may include the third metal layer. The first power signal line PVDD may not only be at the second metal layer M2 but may also include a portion at the third metal layer to form a parallel structure to reduce impedance. The film-layer structure of the display panel may be only taken as an example for illustration in one embodiment. In an implementation, the film-layer structure of the display panel may include but may not be limited to above-mentioned structure.

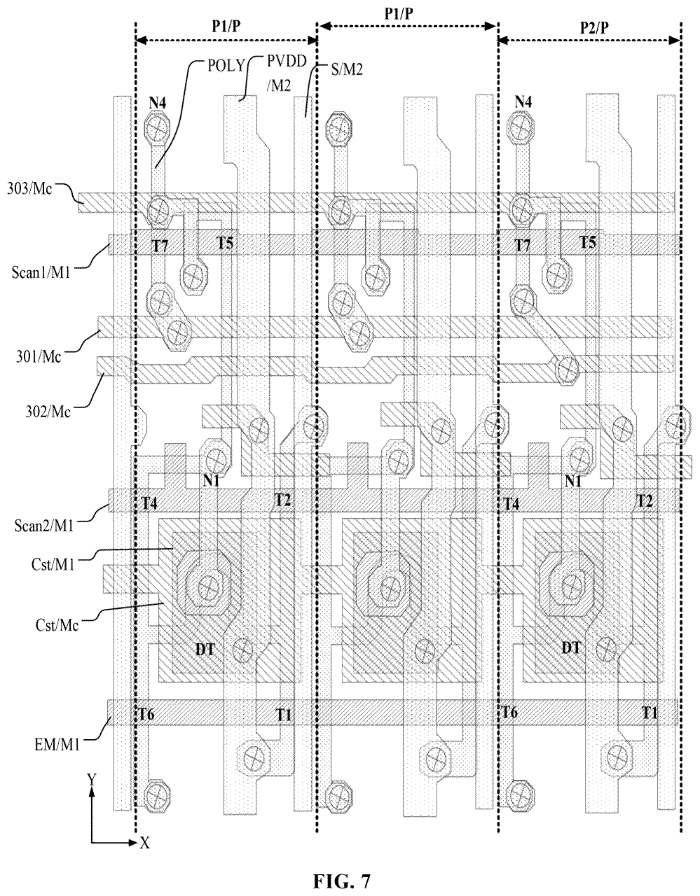

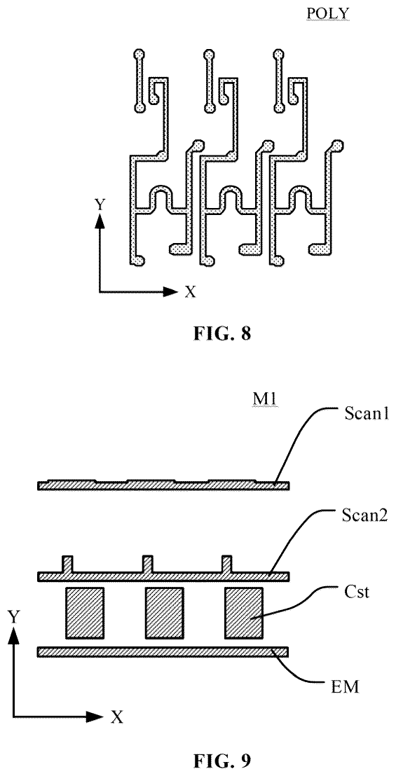

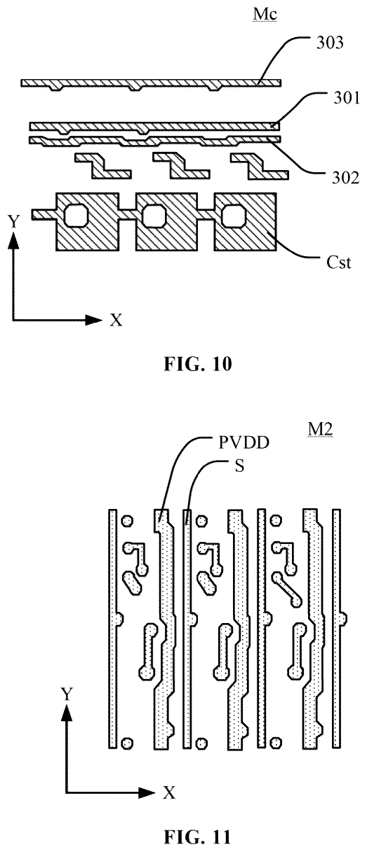

In some optional embodiments, referring to FIGS. 1-3 and 6-7, FIG. 7 illustrates a circuit layout when the pixel circuit structure in FIG. 6 is formed on the substrate of the display panel. It may be understood that, in order to clearly illustrate the structure in one embodiment, transparency filling is performed in FIG. 7. When above-mentioned exemplary pixel circuit 10 is formed on the substrate 00 included in the display panel 000, the circuit layout is exemplarily shown in FIG. 7. Referring to FIGS. 8-11, FIG. 8 illustrates a structural schematic of the semiconductor layer in FIG. 7; FIG. 9 illustrates a structural schematic of the first metal layer in FIG. 7; FIG. 10 illustrates a structural schematic of the capacitor metal layer in FIG. 7; and FIG. 11 illustrates a structural schematic of the second metal layer in FIG. 7. FIGS. 8-11 are sequentially superimposed to form the layout of the pixel circuit illustrated in FIG. 7. In one embodiment, the first reference voltage signal line 301 and the second reference voltage signal line 302 may be disposed at a same layer, for example, both at the capacitor metal layer Mc. Optionally, the third reference voltage signal line 303 may also be disposed at the capacitor metal layer Mc; and the extension direction of the first reference voltage signal line 301 and the extension direction of the second reference voltage signal line 302 may be same. As shown in FIGS. 2 and 7, the extension direction of the first reference voltage signal line 301 and the extension direction of the second reference voltage signal line 302 may be both the first direction X. Optionally, the third reference voltage signal line 303 may also extend along the first direction X, such that the reference voltage signal lines in the panel to be formed using a same film layer and a same process, which may be beneficial for saving process steps and improving process efficiency.

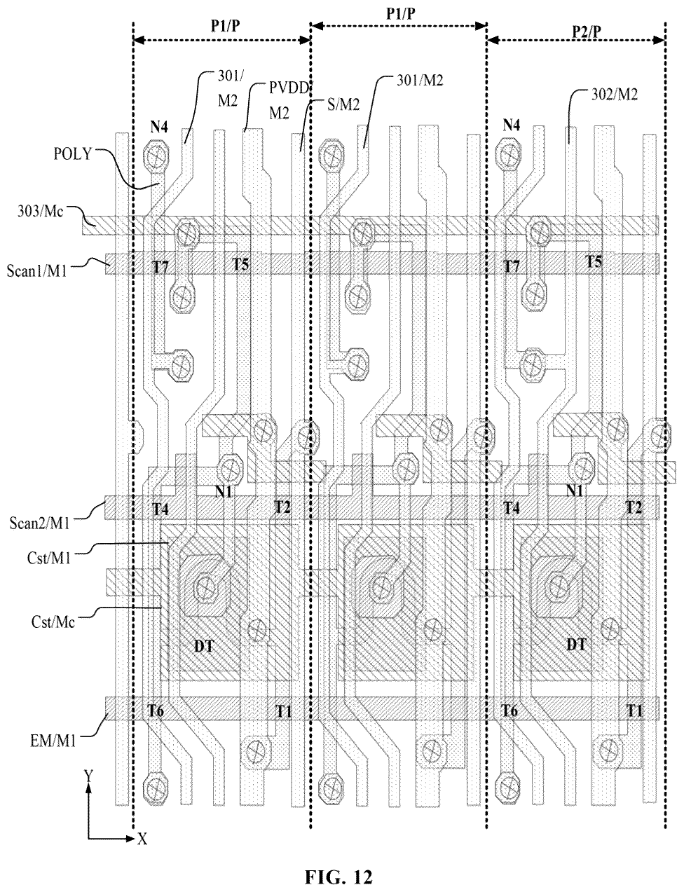

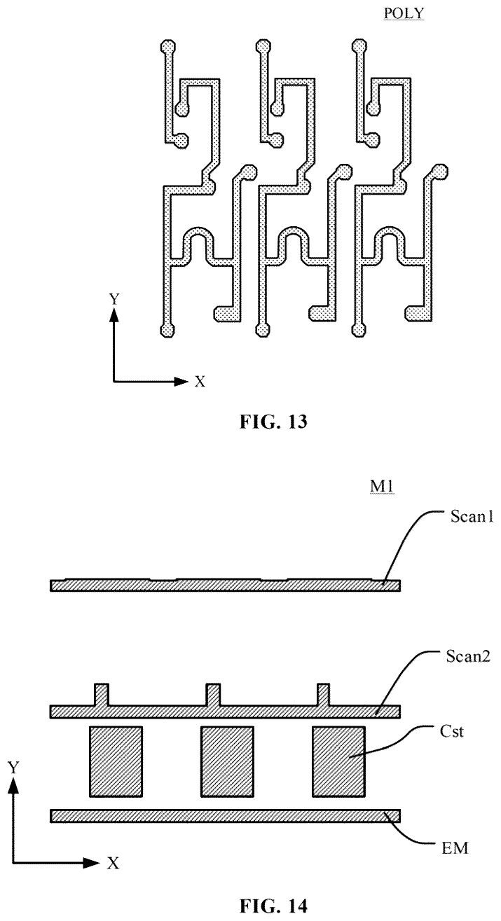

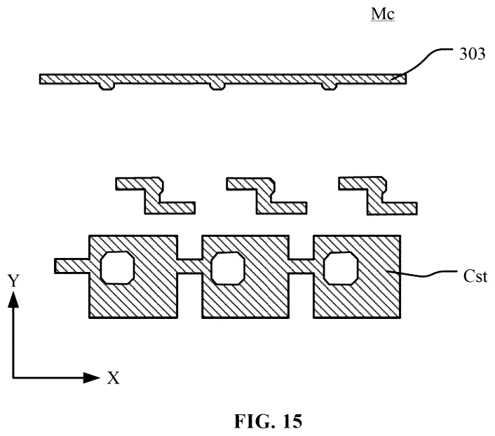

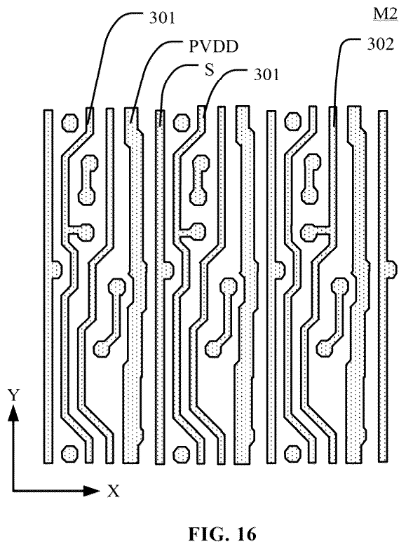

In some optional embodiments, referring to FIGS. 1, 3, 4, 6 and 12, FIG. 12 illustrates another circuit layout when the pixel circuit structure in FIG. 6 is formed on the substrate of the display panel. It may be understood that, in order to clearly illustrate the structure of one embodiment, transparency filling is performed in FIG. 12. When above-mentioned exemplary pixel circuit 10 is formed on the substrate 00 included in the display panel 000, the circuit layout is exemplarily shown in FIG. 12. Referring to FIGS. 13-16, FIG. 13 illustrates a structural schematic of the semiconductor layer in FIG. 12; FIG. 14 illustrates a structural schematic of the first metal layer in FIG. 12; FIG. 15 illustrates a structural schematic of the capacitor metal layer in FIG. 12; and FIG. 16 illustrates a structural schematic of the second metal layer in FIG. 12. FIGS. 13-16 are sequentially superimposed to form the layout of the pixel circuit illustrated in FIG. 12. In one embodiment, the first reference voltage signal line 301 and the second reference voltage signal line 302 may be disposed at a same layer, for example, both at the second metal layer M2. Optionally, the third reference voltage signal line 303 may still be disposed at the capacitor metal layer Mc; and the extension direction of the first reference voltage signal line 301 and the extension direction of the second reference voltage signal line 302 may be same. As shown in FIGS. 4 and 12, the extension direction of the first reference voltage signal line 301 and the extension direction of the second reference voltage signal line 302 at the second metal layer M2 may be both the second direction Y. Optionally, the third reference voltage signal line 303 at the capacitor metal layer Mc may still extend along the first direction X, such that the number of signal lines along the second direction Y in the capacitor metal layer Mc may be reduced as possible, and the layout space of the signal lines along the second direction Y in the capacitor metal layer Mc may be saved. Therefore, the space occupied by the pixel circuit 10 along the second direction Y may be reduced as possible, which may be beneficial for improving panel resolution, reducing the difficulty of spatial wiring of the capacitor metal layer Mc, and improving process efficiency.

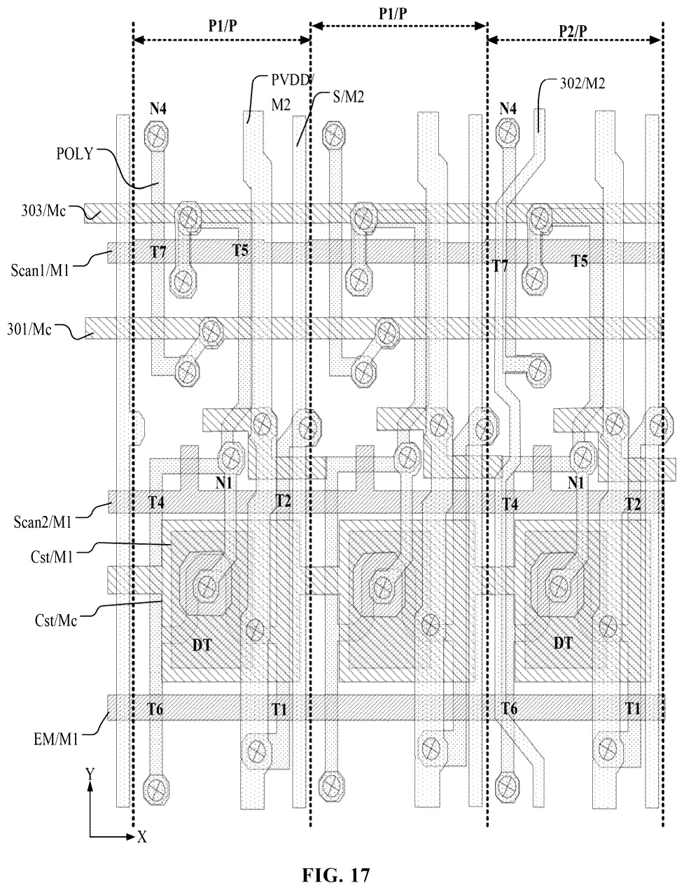

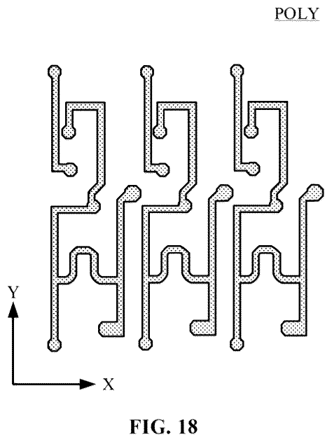

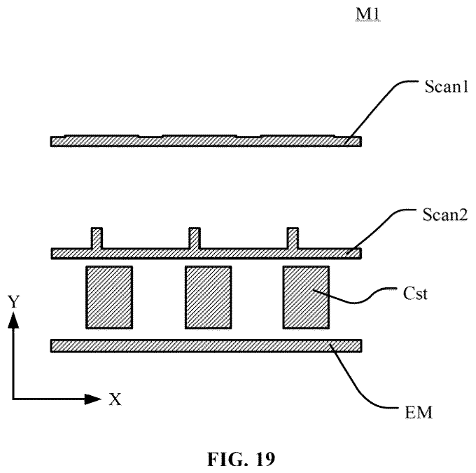

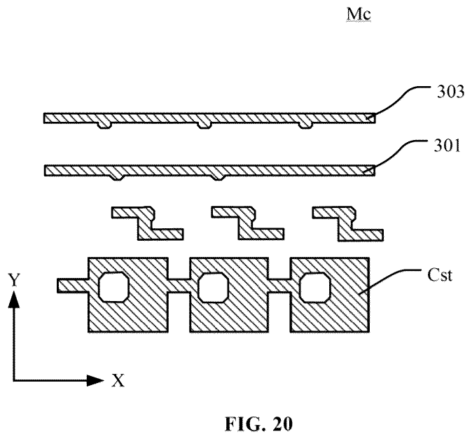

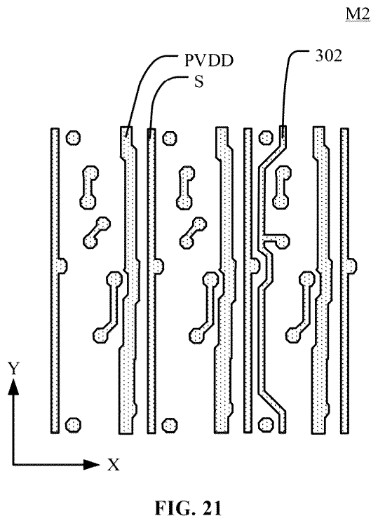

In some optional embodiments, referring to FIGS. 1, 3, 5, 6 and 17, FIG. 17 illustrates another circuit layout when the pixel circuit structure in FIG. 6 is formed on the substrate of the display panel. It may be understood that, in order to clearly illustrate the structure of one embodiment, transparency filling is performed in FIG. 17. When above-mentioned exemplary pixel circuit 10 is formed on the substrate 00 included in the display panel 000, the circuit layout is exemplarily shown in FIG. 17. Referring to FIGS. 18-21, FIG. 18 illustrates a structural schematic of the semiconductor layer in FIG. 17; FIG. 19 illustrates a structural schematic of the first metal layer in FIG. 17; FIG. 20 illustrates a structural schematic of the capacitor metal layer in FIG. 17; and FIG. 21 illustrates a structural schematic of the second metal layer in FIG. 17. FIGS. 18-21 are sequentially superimposed to form the layout of the pixel circuit illustrated in FIG. 17. In one embodiment, the first reference voltage signal line 301 and the second reference voltage signal line 302 may be disposed at different layers. For example, the first reference voltage signal line 301 may be at the capacitor metal layer Mc, and the second reference voltage signal line 302 may be at the second metal layer M2. Optionally, the third reference voltage signal line 303 may also be disposed at the capacitor metal layer Mc; and the extension direction of the first reference voltage signal line 301 and the extension direction of the second reference voltage signal line 302 may be different. As shown in FIGS. 5 and 17, the first reference voltage signal line 301 at the capacitor metal layer Mc may extend along the first direction X, and the second reference voltage signal line 302 at the second metal layer M2 may extend along the second direction Y. Optionally, the third reference voltage signal line 303 may be at the capacitor metal layer Mc and still extend along the first direction X, such that the layout space of the signal lines along the first direction X in the second metal layer M2 may be saved, which may provide sufficient layout space for the data lines S and the first power signal lines PVDD of the second metal layer M2. Therefore, the space occupied by the pixel circuit 10 along the first direction X may be reduced as possible, which may be beneficial for improving panel resolution, reducing the difficulty of spatial wiring of the second metal layer M2, and improving process efficiency.

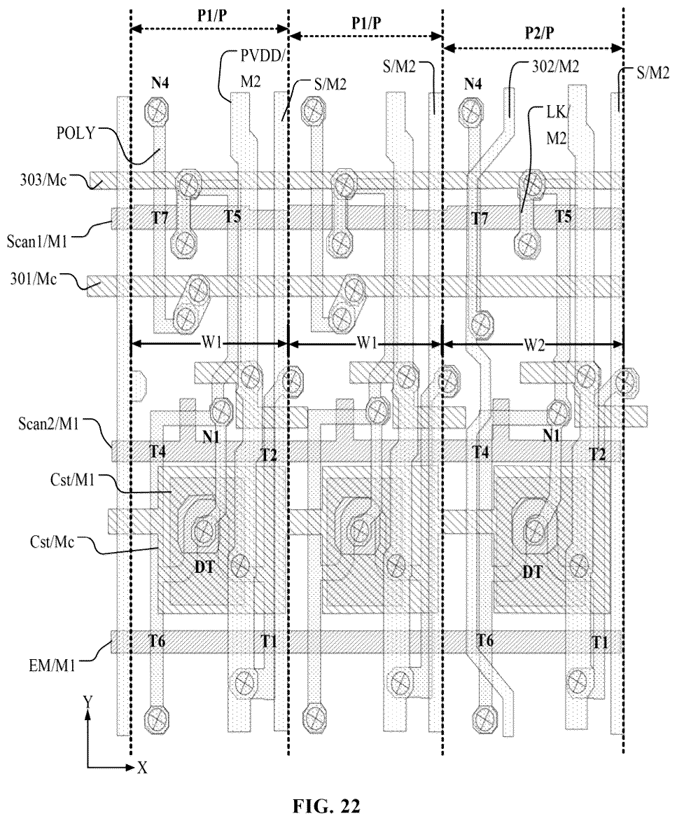

Referring to FIGS. 1, 3, 5, 6 and 22, FIG. 22 illustrates another circuit layout when the pixel circuit structure in FIG. 6 is formed on the substrate of the display panel. It may be understood that, in order to clearly illustrate the structure of one embodiment, transparency filling is performed in FIG. 22. When above-mentioned exemplary pixel circuit 10 is formed on the substrate 00 included in the display panel 000, the circuit layout is exemplarily shown in FIG. 22. In one embodiment, along the first direction X, the width W1 of the pixel circuit 10 of the first color sub-pixel P1 may be less than the width W2 of the pixel circuit 10 of the second color sub-pixel P2. It may be understood that, as shown in FIG. 22, in one embodiment, the width W1 of the pixel circuit 10 of the first color sub-pixel P1 may be understood as the distance between the data line S electrically connected to the first color sub-pixel P1 and the data line S electrically connected to its adjacent sub-pixel; and the width W2 of the pixel circuit 10 of the second color subpixel P2 may be understood as the distance between the data line S electrically connected to the second color subpixel P2 and the data line S electrically connected to the adjacent first color subpixel P1.

In one embodiment, it describes that in the pixel circuit 10 of the second color sub-pixel P2, when the second reference voltage signal line 302 electrically connected to the light-emitting element 20 is disposed at the second metal layer M2 and extends along the second direction Y, a certain space along the first direction X may need to be reserved to dispose the second reference voltage signal line 302. In addition, in the pixel circuit 10 of the first color sub-pixel P1, the first reference voltage signal line 301 electrically connected to the light-emitting element 20 may be disposed at the capacitor metal layer Mc and extend along the first direction X without occupying the width along the first direction X. Therefore, the width W1 of the pixel circuit 10 of the first color sub-pixel P1 along the first direction X may be reduced, such that along the first direction X, the width W1 of the pixel circuit 10 of the first color sub-pixel P1 may be less than the width W2 of the pixel circuit 10 of the second color sub-pixel P2. By suitably increasing the width occupied by the pixel circuit 10 of the second color sub-pixel P2 along the first direction X, it only needs to ensure that three adjacent sub-pixels P as a whole may basically form a square. After the width W2 of the pixel circuit 10 of the second color sub-pixel P2 is increased, larger wiring space may be provided for the second reference voltage signal line 302, which may avoid signal coupling interference problems caused by extremely short distance between the second reference voltage signal line 302 and each of the data line S of the second metal layer M2 and the first power signal line PVDD, thereby being beneficial for ensuring stable signal transmission on each signal line of the second metal layer M2 and display quality.

Optionally, in one embodiment, in the pixel circuit 10 of the first color sub-pixel P1, the first reference voltage signal line 301 electrically connected to the light-emitting element 20 may be disposed at the capacitor metal layer Mc and extend along the first direction X without occupying the width along the first direction X. Therefore, the width W1 of the pixel circuit 10 of the first color sub-pixel P1 along the first direction X may be reduced. Reducing the width W1 of the pixel circuit 10 along the first direction X of the first color sub-pixel P1 may be implemented by reducing the distance between the data line S electrically connected to the first color sub-pixel P1 and the data line S electrically connected to the sub-pixel adjacent to the first color sub-pixel P1. Other film layer structures of the pixel circuit 10 of the first color sub-pixel P1 may be reasonably reduced along the first direction X according to actual spatial layout, which may only need to avoid mutual interference between the conductive structures of a same film layer.

Optionally, in one embodiment, in the pixel circuit 10 of the second color sub-pixel P2, when the second reference voltage signal line 302 electrically connected to the light-emitting element 20 is disposed at the second metal layer M2 and extends along the second direction Y, it needs to reserve a certain space along the first direction X to dispose the second reference voltage signal line 302. Therefore, the source and drain electrodes of the fifth transistor T5 may be connected to each other as shown in FIG. 22. In addition, a connection portion LK at the second metal layer M2 may need to avoid the second reference voltage signal line 302 which is also disposed at the second metal layer M2. Therefore, in the pixel circuit 10 of the second color sub-pixel P2, the semiconductor layer POLY at the position of the fifth transistor T5 may be shortened along the first direction X. However, shortening the semiconductor layer POLY along the first direction X may not mean the reduction of the width W2 of the pixel circuit 10 of the second color sub-pixel P2. The width W2 of entire pixel circuit 10 of the second color sub-pixel P2 may be still understood as the distance between the data line S electrically connected to the second color sub-pixel P2 and the data line S electrically connected to the first color sub-pixel P1 adjacent to the second color sub-pixel P2.

In some optional embodiments, referring to FIGS. 1, 3, 5, 6 and 17-21, the display panel 000 may include the data line S; the pixel circuit 10 may include the storage capacitor Cst; the first reference voltage signal line 301 may be disposed at a same layer as the electrode of the storage capacitor Cst; and the second reference voltage signal line 302 may be disposed as a same layer as the data line S.

In one embodiment, it describes that the first reference voltage signal line 301 electrically connected to the pixel circuit 10 of the first color sub-pixel P1 may be disposed at a different layer as the second reference voltage signal line 302 electrically connected to the pixel circuit 10 of the second color sub-pixel P2. For example, the first reference voltage signal line 301 may be at the capacitor metal layer Mc, that is, the first reference voltage signal line 301 and the electrode of the storage capacitor Cst may be disposed at a same layer; and the second reference voltage signal line 302 may be at the second metal layer M2, that is, the second reference voltage signal line 302 and the data line S may be disposed at a same layer. Therefore, the first reference voltage signal line 301 and the second reference voltage signal line 302 with different extension directions may be at different film layers to avoid short circuit when above signal lines cross with each other. Furthermore, the first reference voltage signal line 301 and the second reference voltage signal line 302 may also be formed using the conductive film layer included in the display panel 000 itself, which may be beneficial for achieving thin panel. In addition, the first reference voltage signal line 301 and the second reference voltage signal line 302 with different extension directions may be at different film layers. In such way, the layout space of the pixel circuit through horizontal and vertical wiring may be ensured; and the via holes for the electrical connection with the pixel circuit formed using original film layer of the display panel may be avoided to be excessively deep when a new film layer is used to form above-mentioned reference voltage signal lines, thereby being beneficial for ensuring electrical connection stability and reducing formation process difficulty.

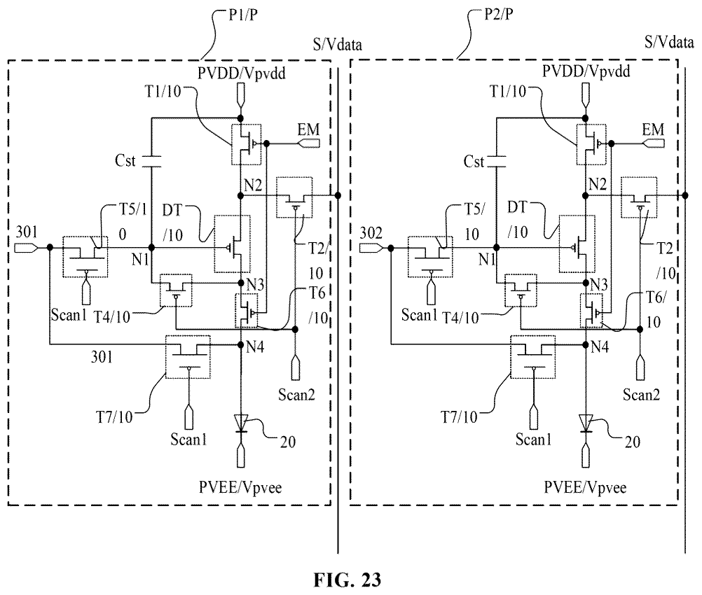

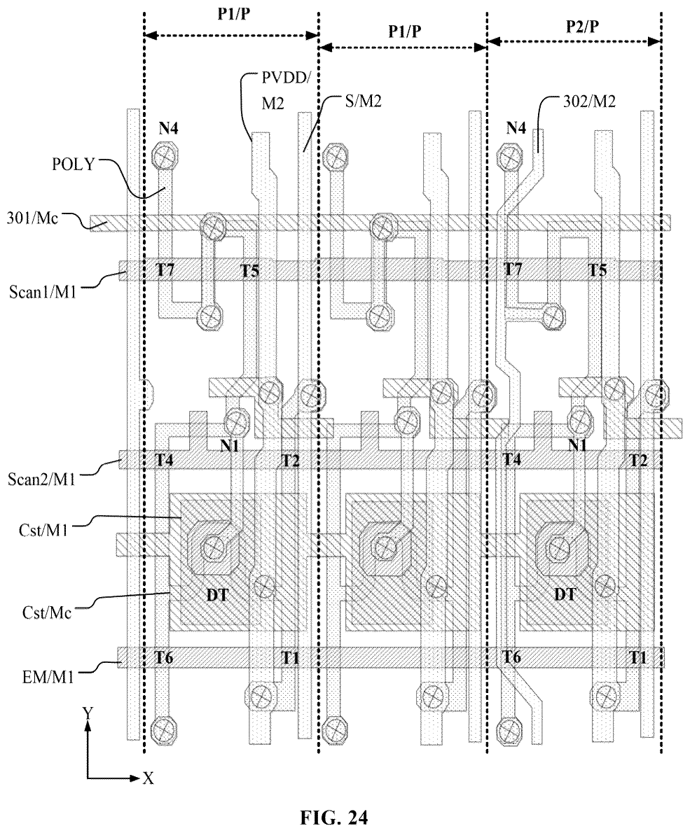

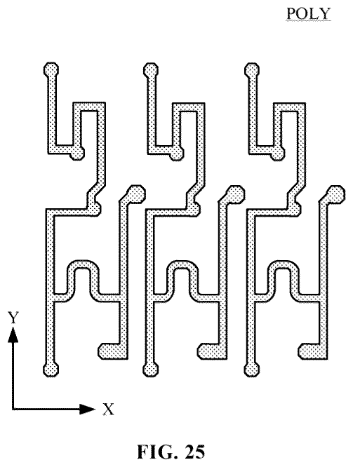

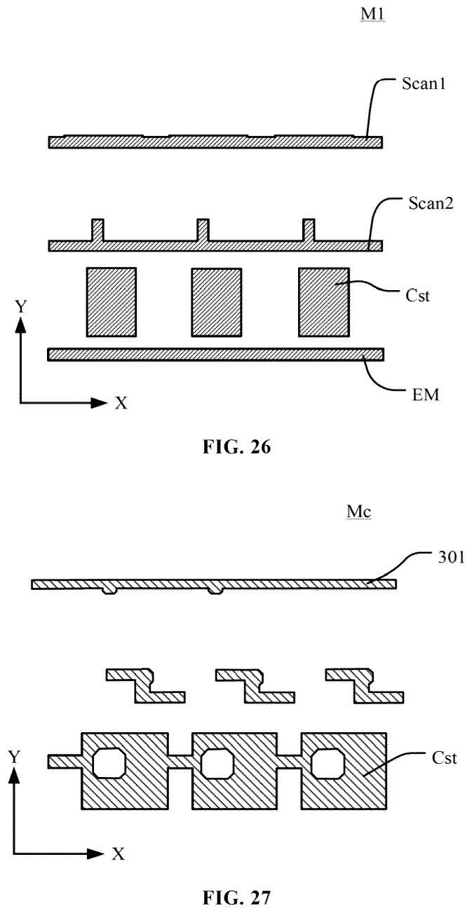

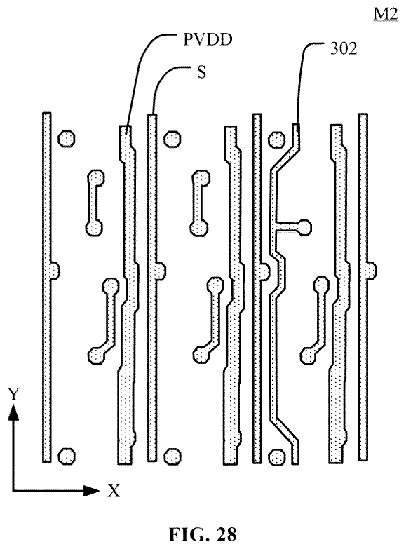

In some optional embodiments, referring to FIGS. 1, 3, 5, 23 and 24, FIG. 23 illustrates another structural schematic of electrical connection of pixel circuits and light-emitting elements of the first color sub-pixel and the second color sub-pixel in the display panel according to various embodiments of the present disclosure; and FIG. 24 illustrates a circuit layout when the pixel circuit structure in FIG. 23 is formed on the substrate of the display panel. It may be understood that, in order to clearly illustrate the structure of one embodiment, transparency filling is performed in FIG. 24. When above-mentioned exemplary pixel circuit 10 is formed on the substrate 00 included in the display panel 000, the circuit layout is exemplarily shown in FIG. 24. Referring to FIGS. 25-28, FIG. 25 illustrates a structural schematic of the semiconductor layer in FIG. 24; FIG. 26 illustrates a structural schematic of the first metal layer in FIG. 24; FIG. 27 illustrates a structural schematic of the capacitor metal layer in FIG. 24; and FIG. 28 illustrates a structural schematic of the second metal layer in FIG. 24. FIGS. 25-28 are sequentially superimposed to form the layout of the pixel circuit illustrated in FIG. 24. In one embodiment, the pixel circuit 10 may at least include the driving transistor DT.

The first reference voltage signal line 301 may be electrically connected to the gate electrode of the driving transistor DT in the first color sub-pixel P1 (i.e., the first node N1 of the pixel circuit 10 of the first color sub-pixel P1). The second reference voltage signal line 302 may be electrically connected to the gate electrode of the driving transistor DT in the second color sub-pixel P2 (i.e., the first node N1 of the pixel circuit 10 of the second color sub-pixel P2).

In one embodiment, it describes that the reference voltage signal line for resetting the gate electrode of the driving transistor DT of the pixel circuit 10 may be reused as the reference voltage signal line for the anode of the light-emitting element 20. For example, the first reference voltage signal line 301 may be electrically connected to the gate electrode of the driving transistor DT in the first color sub-pixel P1. That is, the first reference voltage signal line 301 may be not only electrically connected to the anode (i.e., the fourth node N4) of the light-emitting element 20 of the pixel circuit 10 of the first color sub-pixel P1, but also electrically connected to the first node N1 of the pixel circuit 10 of the first color sub-pixel P1. The second reference voltage signal line 302 may be electrically connected to the gate electrode of the driving transistor DT in the second color sub-pixel P2. That is, the second reference voltage signal line 302 may be not only electrically connected to the anode (i.e., the fourth node N4) of the light-emitting element 20 of the pixel circuit 10 of the second color sub-pixel P2, but also electrically connected to the first node N1 of the pixel circuit 10 of the second color sub-pixel P2. The first reference voltage signal line 301 may be configured to jointly reset the first node N1 and the fourth node N4 of the pixel circuit 10 of the first color sub-pixel P1. The second reference voltage signal line 302 may be configured to jointly reset the first node N1 and the fourth node N4 of the pixel circuit 10 of the second color sub-pixel P2. Optionally, as shown in FIG. 24, the first reference voltage signal line 301 and the second reference voltage signal line 302 may be disposed at different layers. The first reference voltage signal line 301 may be at the capacitor metal layer Mc; and the second reference voltage signal line 302 may be at the second metal layer M2. The extension direction of the first reference voltage signal line 301 and the extension direction of the second reference voltage signal line 302 may be different. The first reference voltage signal line 301 at the capacitor metal layer Mc may extend along the first direction X, and the second reference voltage signal line 302 at the second metal layer M2 may extend along the second direction Y. Therefore, by sharing the reference voltage signal lines for resetting the first node N1 and the fourth node N4 in a same sub-pixel, the number of signal lines in the panel may be further reduced, which may provide more space for the layout of the pixel circuit 10, reduce wiring difficulty and avoid mutual interference problem caused by a large number of signal lines which are excessively adjacent to each other, thereby being beneficial for further improving the display quality.

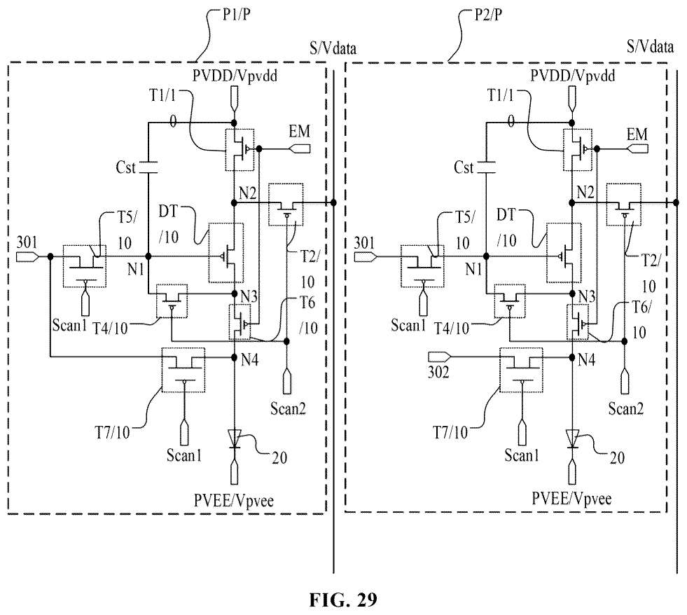

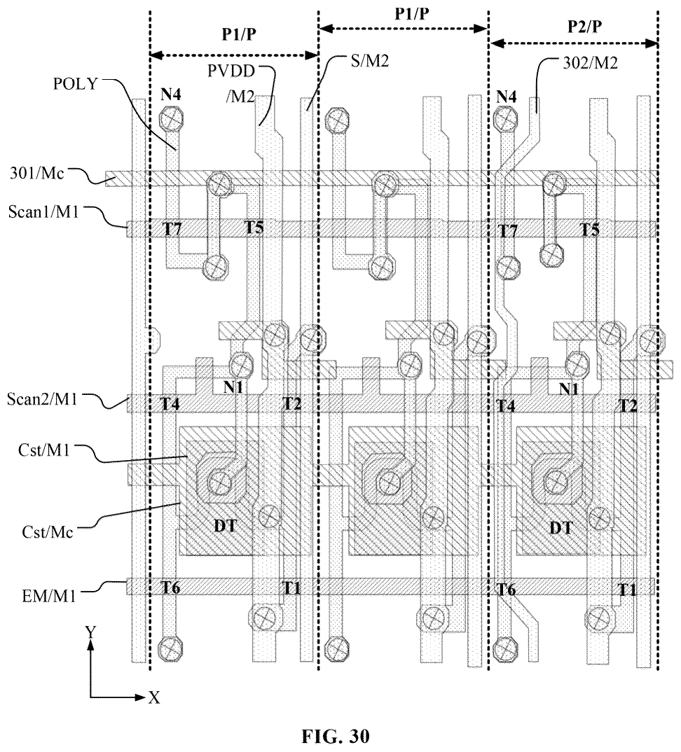

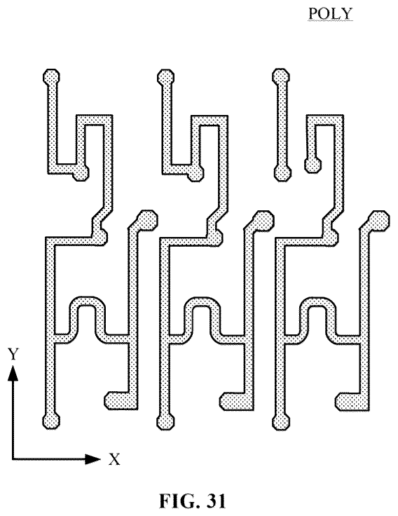

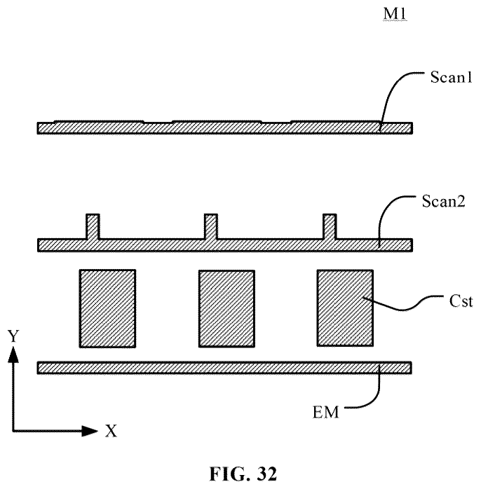

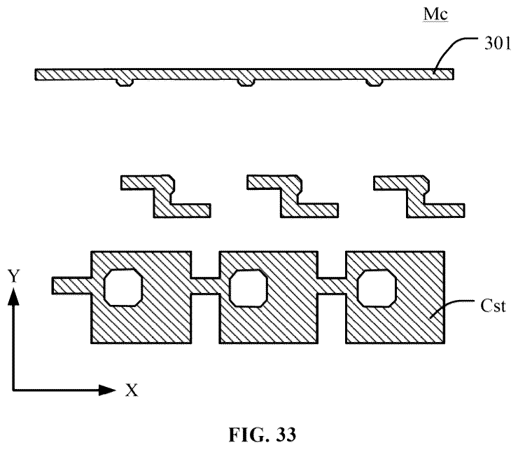

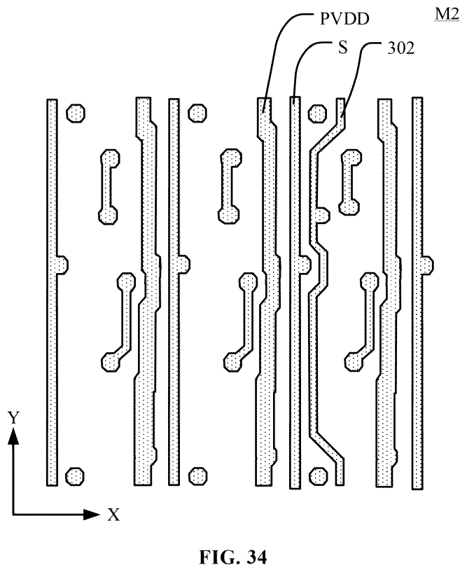

In some optional embodiments, referring to FIGS. 1, 3, 5, 29 and 30, FIG. 29 illustrates another structural schematic of electrical connection of pixel circuits and light-emitting elements of the first color sub-pixel and the second color sub-pixel in the display panel according to various embodiments of the present disclosure; and FIG. 30 illustrates a circuit layout when the pixel circuit structure in FIG. 29 is formed on the substrate of the display panel. It may be understood that, in order to clearly illustrate the structure of one embodiment, transparency filling is performed in FIG. 30. When above-mentioned exemplary pixel circuit 10 is formed on the substrate 00 included in the display panel 000, the circuit layout is exemplarily shown in FIG. 30. Referring to FIGS. 31-34, FIG. 31 illustrates a structural schematic of the semiconductor layer in FIG. 30; FIG. 32 illustrates a structural schematic of the first metal layer in FIG. 30; FIG. 33 illustrates a structural schematic of the capacitor metal layer in FIG. 30; and FIG. 34 illustrates a structural schematic of the second metal layer in FIG. 30. FIGS. 31-34 are sequentially superimposed to form the layout of the pixel circuit illustrated in FIG. 30. In one embodiment, the pixel circuit 10 may at least include the driving transistor DT; the first reference voltage signal line 301 may be electrically connected to the gate electrode of the driving transistor DT in the first color sub-pixel P1 (i.e., the first node N1 in the pixel circuit 10 of the first color sub-pixel P1); and the first reference voltage signal line 301 may be electrically connected to the gate electrode of the driving transistor DT in the second color sub-pixel P2 (i.e., the first node N1 in the pixel circuit 10 of the second color sub-pixel P2).

In one embodiment, it describes that the reference voltage signal line for resetting the gate electrode of the driving transistor DT of the pixel circuit 10 may be reused as the reference voltage signal line for resetting the anode of the light-emitting element 20. For example, the first reference voltage signal line 301 may be not only electrically connected to the anode of the light-emitting element 20 in the first color sub-pixel P1 to provide a reset signal for the anode of the light-emitting element 20 in the first color sub-pixel P1, and also be electrically connected to the gate electrode of the driving transistor DT in the first color sub-pixel P1 (i.e., the first node N1 in the pixel circuit 10 of the first color sub-pixel P1). In addition, the first reference voltage signal line 301 may be also electrically connected to the gate electrode of the driving transistor DT in the second color sub-pixel P2 (i.e., the first node N1 in the pixel circuit 10 of the second color sub-pixel P2). That is, the first reference voltage signal line 301 for transmitting the reference signal with a relatively small voltage value may be not only configured to reset the light-emitting element of the pixel circuit 10 in the first color sub-pixel P1 but also configured to reset the gate electrodes of the driving transistors DT of the first color sub-pixel P1 and the second color sub-pixel P2 in the display panel (that is, the first nodes N1 in the pixel circuits 10 of the first color sub-pixel P1 and the second color sub-pixel P2). In such way, the second reference voltage signal line 302 at the second metal layer M2 may extend along the second direction Y, and the second reference voltage signal line 302 may only need to be electrically connected to the fourth node N4 in the pixel circuit 10 of the second color sub-pixel P2. Therefore, the number of reference voltage signal lines in the display panel may be further reduced to provide more space for the layout of the pixel circuit 10, which may avoid mutual interference problem caused by a large number of signal lines which are excessively adjacent to each other, thereby being beneficial for further improving the display quality.

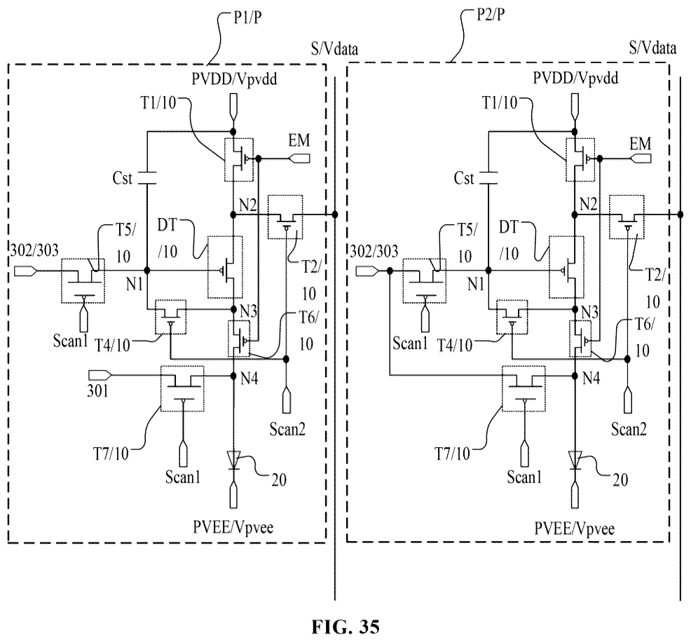

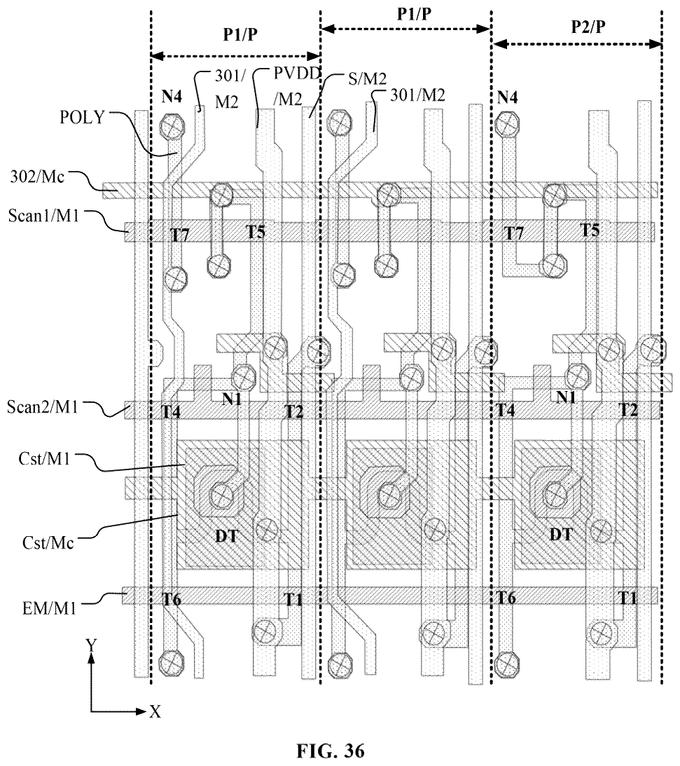

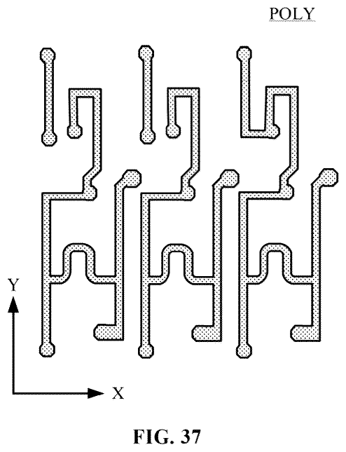

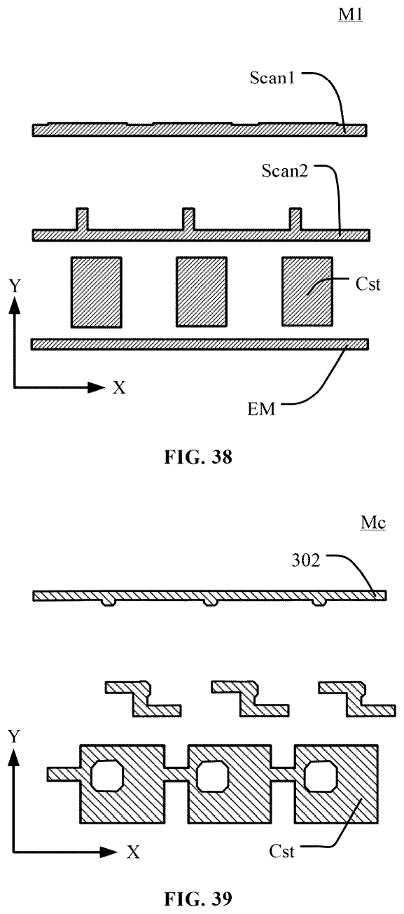

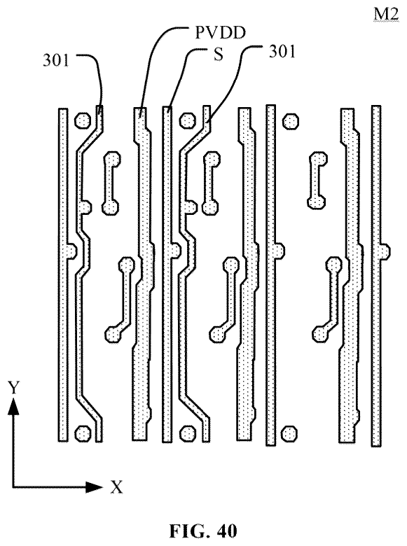

In some optional embodiments, referring to FIGS. 1, 3, 5, 35 and 36, FIG. 35 illustrates another structural schematic of electrical connection of pixel circuits and light-emitting elements of the first color sub-pixel and the second color sub-pixel in the display panel according to various embodiments of the present disclosure; and FIG. 36 illustrates a circuit layout when the pixel circuit structure in FIG. 35 is formed on the substrate of the display panel. It may be understood that, in order to clearly illustrate the structure of one embodiment, transparency filling is performed in FIG. 36. When above-mentioned exemplary pixel circuit 10 is formed on the substrate 00 included in the display panel 000, the circuit layout is exemplarily shown in FIG. 36. Referring to FIGS. 37-40, FIG. 37 illustrates a structural schematic of the semiconductor layer in FIG. 36; FIG. 38 illustrates a structural schematic of the first metal layer in FIG. 36; FIG. 39 illustrates a structural schematic of the capacitor metal layer in FIG. 36; and FIG. 40 illustrates a structural schematic of the second metal layer in FIG. 36. FIGS. 37-40 are sequentially superimposed to form the layout of the pixel circuit shown in FIG. 36. In one embodiment, the pixel circuit 10 may at least include the driving transistor DT; the second reference voltage signal line 302 may be electrically connected to the gate electrode of the driving transistor DT in the first color sub-pixel P1; and the second reference voltage signal line 302 may be electrically connected to the gate electrode of the driving transistor DT in the second color sub-pixel P2.

In one embodiment, it describes that the reference voltage signal line for resetting the gate electrode of the driving transistor DT of the pixel circuit 10 may be reused as the reference voltage signal line for the anode of the light-emitting element 20. For example, the second reference voltage signal line 302 may be not only electrically connected to the anode of the light-emitting element 20 in the second color sub-pixel P2 to provide a reset signal for the anode of the light-emitting element 20 in the second color sub-pixel P2, and may also be electrically connected to the gate electrode of the driving transistor DT in the first color sub-pixel P1 (i.e., the first node N1 in the pixel circuit 10 of the first color sub-pixel P1). In addition, the second reference voltage signal line 302 may be also electrically connected to the gate electrode of the driving transistor DT in the second color sub-pixel P2 (i.e., the first node N1 in the pixel circuit 10 of the second color sub-pixel P2). That is, the second reference voltage signal line 302 for transmitting the reference signal with a relatively large voltage value may be not only configured to reset the light-emitting element of the pixel circuit 10 in the second color sub-pixel P2, but also configured to reset the gate electrodes of the driving transistors DT of the first color sub-pixel P1 and the second color sub-pixel P2 in the display panel (that is, the first nodes N1 in the pixel circuits 10 of the first color sub-pixel P1 and the second color sub-pixel P2). In such way, the first reference voltage signal line 301 may only need to be electrically connected to the fourth node N4 in the pixel circuit 10 of the first color sub-pixel P1. Therefore, the number of reference voltage signal lines in the panel may be further reduced to provide more space for the layout of the pixel circuit 10, which may avoid mutual interference problem caused by a large number of signal lines which are excessively adjacent to each other, thereby being beneficial for further improving the display quality.

Optionally, referring to FIG. 36, in one embodiment, the extension directions of the first reference voltage signal line 301 and the second reference voltage signal line 302 may intersect with each other, and the first reference voltage signal line 301 and the second reference voltage signal line 302 may be disposed at different layers; the first reference voltage signal line 301 may extend along the second direction Y and may be at the second metal layer M2; and the second reference voltage signal line 302 may extend along the first direction X and may be at the capacitive metal layer Mc. During an implementation manner, other arrangement manners may be selected for the extension directions and film layer arrangements of the first reference voltage signal line 301 and the second reference voltage signal line 302; and FIG. 36 may be exemplary for illustration in one embodiment.

Moreover, in one embodiment, the second reference voltage signal line 302 for transmitting the reference signal with a relatively large voltage value may be not only configured to reset the light-emitting element of the pixel circuit 10 in the second color sub-pixel P2 and also configured to reset the gate electrodes of the driving transistors DT of the first color sub-pixel P1 and the second color sub-pixel P2 in the display panel (that is, the first nodes N1 in the pixel circuits 10 of the first color sub-pixel P1 and the second color sub-pixel P2). In such way, after the reset stage is completed, although the potential of the first node N1 of the pixel circuit 10 in the second color sub-pixel P2 is equal to the potential of the fourth node N4 of the pixel circuit 10 in the second color sub-pixel P2 (both are relatively large voltage values provided by the second reference voltage signal line 302), at least the potential of the first node N1 of the pixel circuit 10 in the first color sub-pixel P1 may be greater than the potential of the fourth node N4 of the pixel circuit 10 in the first color sub-pixel P1. When the data write module in the data write stage writes the fixed data voltage signal transmitted on the data line S into the gate electrode of the driving transistor DT, if the reset signal value for resetting the gate electrode of the driving transistor DT is extremely low, the potential of the gate of the driving transistor DT (that is, the potential of the first node N1) may be pulled extremely low. Therefore, the gate electrode of the driving transistor DT may be likely to be not fully charged, and a longer write time may be needed when writing the data voltage signal, which may result in insufficient compensation of the driving transistor DT, the brightness failure to reach the target value and uneven display. Furthermore, the reset signal value for resetting the anode of the light-emitting element 20 may be expected to be lower, such that the anode of the light-emitting element 20 may be reset more completely, which may avoid sub-pixel undesired display caused by lateral leakage current between the light-emitting elements 20 of adjacent sub-pixels. Therefore, in one embodiment, it configures that at least the potential of the first node N1 of the pixel circuit 10 in the first color sub-pixel P1 may be greater than the potential of the fourth node N4 of the pixel circuit 10 in the first color sub-pixel P1. Therefore, the threshold value of the middle driving transistor DT of the first color sub-pixel P1 may be more fully compensated. In such way, it may avoid that the potential of the first node N1 of the pixel circuit 10 in the first color sub-pixel P1 may be pulled down to a same low level as the potential of the fourth node N4, which may cause the threshold compensation of the driving transistor DT of the first color sub-pixel P1 to be insufficient to affect the display uniformity, which may be beneficial for reducing the problem of uneven display caused by insufficient compensation and further improving the display quality. In addition, the potential of the fourth node N4 of the first color sub-pixel P1 may be separately pulled down through the first reference voltage signal line 301. That is, the voltage value of the initial reference signal at the anode of the first color sub-pixel P1 light-emitting element 20 may be separately pulled down. Even if the first color sub-pixel P1 is affected by the common film layer to charge the anode of the light-emitting element 20 when the second color sub-pixel P2 is turned on to achieve the monochrome picture, longer charging time and more charges may be needed to reach the target turn-on voltage for the first color sub-pixel P1; and the light-emitting element 20 of the first color sub-pixel P1 may be less likely to be turned on. Therefore, the undesired display problem of the first color sub-pixel P1 when the monochrome picture of the second color sub-pixel P2 is turned on may be effectively reduced, which may be beneficial for improving the display quality.

In some optional embodiments, referring to FIGS. 1 and 6-21, the display panel 000 may also include the third reference voltage signal line 303.

The pixel circuit 10 may at least include the driving transistor DT; the third reference voltage signal line 303 may be electrically connected to the gate electrode of the driving transistor DT in the first color sub-pixel P1; and the third reference voltage signal line 303 may be electrically connected to the gate electrode of the driving transistor DT in the second color sub-pixel P2.

Optionally, the voltage value of the reference signal transmitted on the third reference voltage signal line 303 may be greater than the voltage value of the reference signal transmitted on the first reference voltage signal line 301; and the voltage value of the reference signal transmitted on the third reference voltage signal line 303 may be greater than the voltage value of the reference signal transmitted on the second reference voltage signal line 302.

Optionally, as shown in FIG. 7, the extension direction of the third reference voltage signal line 303, the extension direction of the first reference voltage signal line 301, and the extension direction of the second reference voltage signal line 302 may all be same. The third reference voltage signal line 303, the second reference voltage signal line 302, and the first reference voltage signal line 301 may all extend along the first direction X; and the third reference voltage signal line 303, the second reference voltage signal line 302, and the first reference voltage signal line 301 may all be disposed at the capacitor metal layer Mc in the display panel 000, which may simplify the process steps and improve the process efficiency.

Optionally, as shown in FIG. 17, the extension direction of the third reference voltage signal line 303 may be same as the extension direction of the first reference voltage signal line 301; the extension direction of the second reference voltage signal line 302 may intersect the extension direction of the first reference voltage signal line 301; the third reference voltage signal line 303 and the first reference voltage signal line 301 may both extend along the first direction X; the third reference voltage signal line 303 and the first reference voltage signal line 301 may both be at the capacitor metal layer Mc; the second reference voltage signal line 302 may extend along the second direction Y; and the second reference voltage signal line 302 may be at the second metal layer M2. Therefore, the layout space of the signal lines along the first direction X in the second metal layer M2 may be saved to provide sufficient layout space for the data line S and the first power signal line PVDD of the second metal layer M2. In such way, the space occupied by the pixel circuit 10 along the first direction X may be reduced as possible, which may be beneficial for improving the panel resolution, reducing the spatial wiring difficulty of the second metal layer M2 and improving the process efficiency.

Optionally, as shown in FIG. 12, the extension direction of the third reference voltage signal line 303 may intersect the extension direction of the first reference voltage signal line 301; the extension direction of the second reference voltage signal line 302 may be same as the extension direction of the first reference voltage signal line 301; and the second reference voltage signal line 302 and the first reference voltage signal line 301 may both extend along the second direction Y. In addition, the second reference voltage signal line 302 and the first reference voltage signal line 301 may both be at the second metal layer M2, the third reference voltage signal line 303 may extend along the first direction X, and the third reference voltage signal line 303 may be at the capacitive metal layer Mc. Therefore, the number of signal lines along the second direction Y in the capacitor metal layer Mc may be reduced as possible, and the layout space of the signal lines along the second direction Y in the capacitor metal layer Mc may be saved. In such way, the space occupied by the pixel circuit 10 along the second direction Y may be reduced as possible, which may be beneficial for improving the panel resolution, reducing the spatial wiring difficulty of the capacitor metal layer Mc and improving the process efficiency.

In one embodiment, it describes that in each sub-pixel P of the display panel 000, the reference voltage signal line configured to provide the reset voltage signal to the gate electrode of the driving transistor DT of the pixel circuit 10 of each sub-pixel P may be disposed independently, such that the display panel 000 may further include the third reference voltage signal line 303. The third reference voltage signal line 303 may be not only electrically connected to the gate electrode of the driving transistor DT in the first color sub-pixel P1, but also electrically connected to the gate electrode of the driving transistor DT in the second color sub-pixel P2. Therefore, by independently disposing the third reference voltage signal line 303, the voltage value of the reference signal transmitted on the third reference voltage signal line 303 may be not only greater than the voltage value of the reference signal transmitted on the first reference voltage signal line 301 but also greater than the voltage value of the reference signal transmitted on the second reference voltage signal line 302. Moreover, after the first color sub-pixel P1 completes the reset stage, the potential of the gate electrode of the driving transistor DT may be greater than the potential of the anode of the light-emitting element 20; and after the second color sub-pixel P2 completes the reset stage, the potential of the gate electrode of the driving transistor DT may be also greater than the potential of the anode of the light-emitting element 20. Furthermore, for a same sub-pixel P, by pulling up the reset signal of the gate electrode of the driving transistor DT, the threshold value of the driving transistor DT of each sub-pixel P may be more fully compensated, thereby reducing uneven display problem caused by insufficient compensation and being beneficial for further improving the display quality.

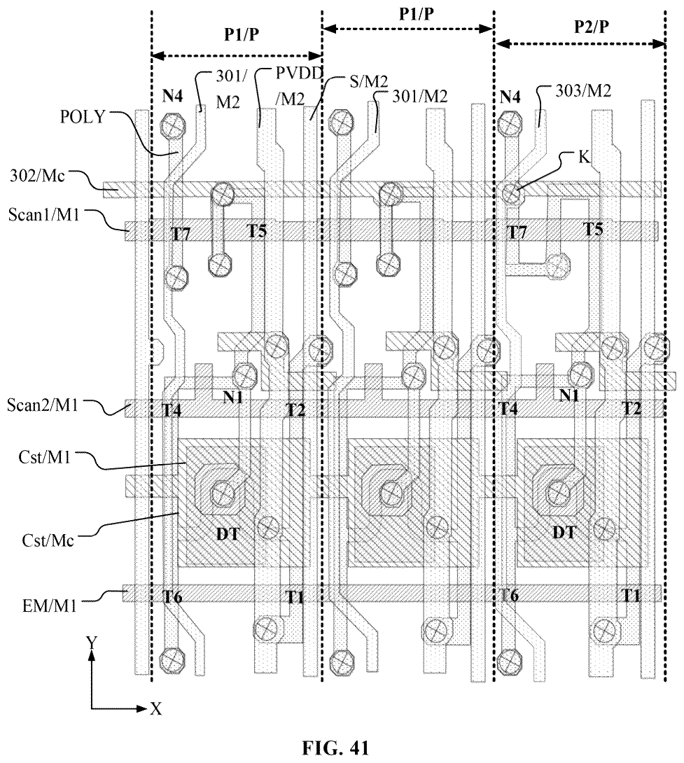

In some optional embodiments, referring to FIGS. 1, 3, 5, 35 and 41, FIG. 41 illustrates a circuit layout when the pixel circuit structure in FIG. 35 is formed on the substrate of the display panel. It may be understood that, in order to clearly illustrate the structure of one embodiment, transparency filling is performed in FIG. 41. When above-mentioned exemplary pixel circuit 10 is formed on the substrate 00 included in the display panel 000, the circuit layout is exemplarily shown in FIG. 41. In one embodiment, for the gate electrode of the driving transistor DT of each sub-pixel P (i.e., the first node N1 of the pixel circuit 10 of each sub-pixel P), the voltage value of the reference signal, which is transmitted on the third reference voltage signal line 303 and configured to reset the gate electrode of the driving transistor DT of each sub-pixel P (i.e., the first node N1 of the pixel circuit 10 of each sub-pixel P), may be equal to the voltage value of the reference signal transmitted on the second reference voltage signal line 302.

Optionally, the extension directions of the third reference voltage signal line 303 and the second reference voltage signal line 302 may be intersected with each other. As shown in FIG. 41, the third reference voltage signal line 303 may be at the second metal layer M2 and extend along the second direction Y; the second reference voltage signal line 302 may be at the capacitor metal layer Mc and extend along the first direction X; and the third reference voltage signal line 303 and the second reference voltage signal line may be connected to form a grid structure through via holes at intersection positions. At this point, the first reference voltage signal line 301 may still extend along the second direction Y and may be at the second metal layer M2, configured to separately pull down the potential of the anode of the light-emitting element 20 of the first color sub-pixel P1 during the reset stage. In addition, the potential of the gate of the driving transistor DT of the first color sub-pixel P1 and the potential of the gate of the driving transistor DT of the second color sub-pixel P2 may be pulled up through the third reference voltage signal line 303 and the second reference voltage signal line 302 which are connected to each other, which may be beneficial for reducing uneven display problem caused by insufficient compensation. Moreover, the third reference voltage signal line 303 and the second reference voltage signal line 302 may be connected to each other to form a grid structure in the display panel, which may further reduce the impedance of the third reference voltage signal line 303 and the second reference voltage signal line 302, thereby being beneficial for voltage signal transmission and further improving display uniformity.

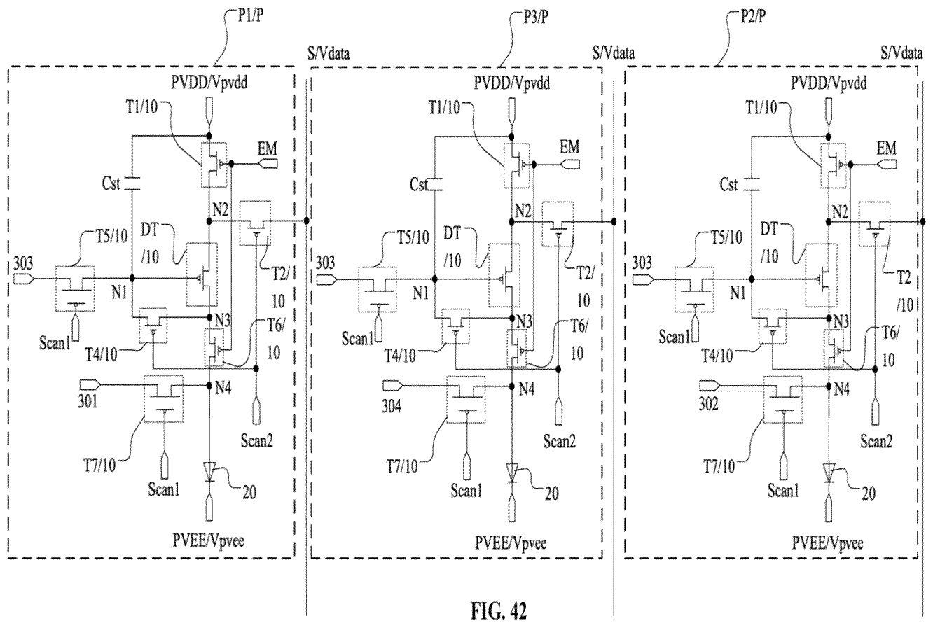

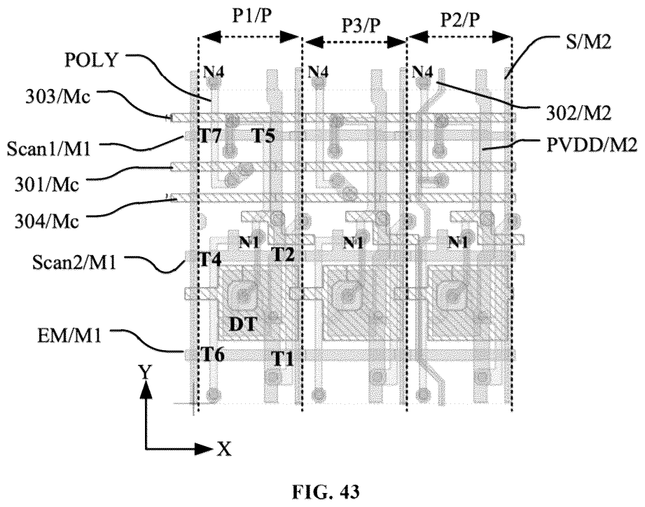

In some optional embodiments, referring to FIGS. 1, 3, 42 and 43, FIG. 42 illustrates another structural schematic of electrical connection of pixel circuits and light-emitting elements of the first color sub-pixel, the second color sub-pixel and the third color sub-pixel in the display panel according to various embodiments of the present disclosure; and FIG. 43 illustrates a circuit layout when the pixel circuit structure in FIG. 42 is formed on the substrate of the display panel. It may be understood that, in order to clearly illustrate the structure of one embodiment, transparency filling is performed in FIG. 43. When above-mentioned exemplary pixel circuit 10 is formed on the substrate 00 included in the display panel 000, the circuit layout is exemplarily shown in FIG. 43. In one embodiment, the plurality of sub-pixels P with different colors may also include the third color sub-pixel P3. The first color sub-pixel P1 may be the red sub-pixel, the second color sub-pixel P2 may be the blue sub-pixel, and the third color sub-pixel P3 may be the green sub-pixel. Therefore, the turn-on voltage of the light-emitting element 20 of the first color sub-pixel P1 may be less than the turn-on voltage of the light-emitting element 20 of the third color sub-pixel P3; and the turn-on voltage of the light-emitting element 20 of the third color sub-pixel P3 may be less than the turn-on voltage of the light-emitting element 20 of the second color sub-pixel P2. The display panel 000 may further include the fourth reference voltage signal line 304, which may be electrically connected to the anode of the light-emitting element 20 of the third color sub-pixel P3. The voltage value of the reference signal transmitted on the first reference voltage signal line 301 may be less than the voltage value of the reference signal transmitted on the fourth reference voltage signal line 304; and the voltage value of the reference signal transmitted on the fourth reference voltage signal line 304 may be less than the voltage value of the reference signal transmitted on the second reference voltage signal line 302.

Optionally, as shown in FIG. 43, the extension direction of the fourth reference voltage signal line 304 may be same as the extension direction of the first reference voltage signal line 301; and the extension direction of the fourth reference voltage signal line may intersect the extension direction of the second reference voltage signal line 302. The fourth reference voltage signal line 304 and the first reference voltage signal line 301 may both extend along the first direction X and may be at the capacitor metal layer Mc. The second reference voltage signal line 302 may extend along the second direction Y and may be at the second metal layer M2. In addition, the third reference voltage signal line 303 configured to reset the gate electrode of the driving transistor DT of each different-color sub-pixel P may extend along the first direction X and may be at the capacitive metal layer Mc.

In one embodiment, it describes that the plurality of sub-pixels P with different colors in the display panel 000 may include three sub-pixels with different colors. For example, the first color sub-pixel P1 may be the red sub-pixel, the second color sub-pixel P2 may be the blue sub-pixel, and the third color sub-pixel P3 may be the green sub-pixel. The turn-on voltage of the light-emitting element 20 of the first color sub-pixel P1 may be less than the turn-on voltage of the light-emitting element 20 of the third color sub-pixel P3, and the turn-on voltage of the light-emitting element 20 of the third color sub-pixel P3 may be less than the turn-on voltage of the light-emitting element 20 of the second color sub-pixel P2. Therefore, in one embodiment, the anodes of the light-emitting elements 20 in three sub-pixels P with different colors may be connected to different reference voltage signal lines. For example, the display panel 000 may further include the fourth reference voltage signal line 304. The fourth reference voltage signal line 304 may be electrically connected to the anode of the light-emitting element 20 of the third color sub-pixel P3. The first reference voltage signal line 301 may be electrically connected to the anode of the light-emitting element 20 of the first color sub-pixel P1, and the second reference voltage signal line 302 may be electrically connected to the anode of the light-emitting element 20 of the second color sub-pixel P2. In one embodiment, it configures that the voltage value of the reference signal transmitted on the first reference voltage signal line 301 may be less than the voltage value of the reference signal transmitted on the fourth reference voltage signal line 304, and the voltage value of the reference signal transmitted on the fourth reference voltage signal line 304 may be less than the voltage value of the reference signal transmitted on the second reference voltage signal line 302, thereby being effectively reducing undesired display of other color sub-pixels when the monochrome picture is turned on in the display panel 000 and further being beneficial for improving the display quality.

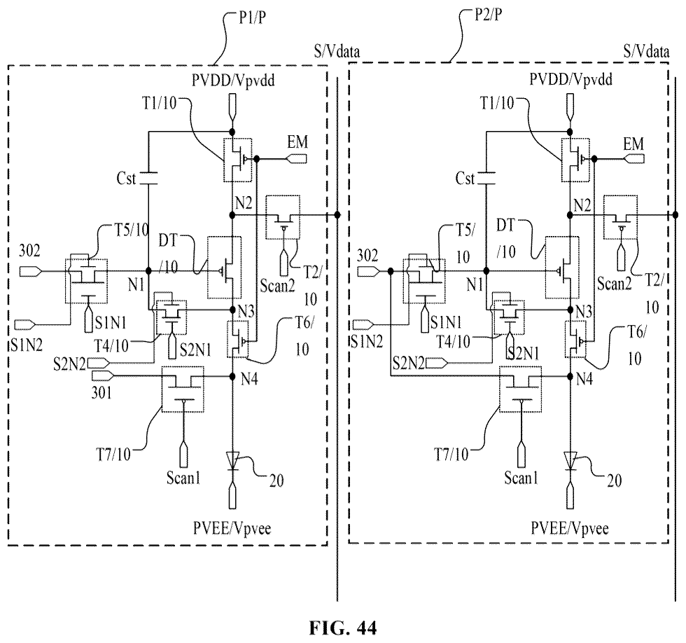

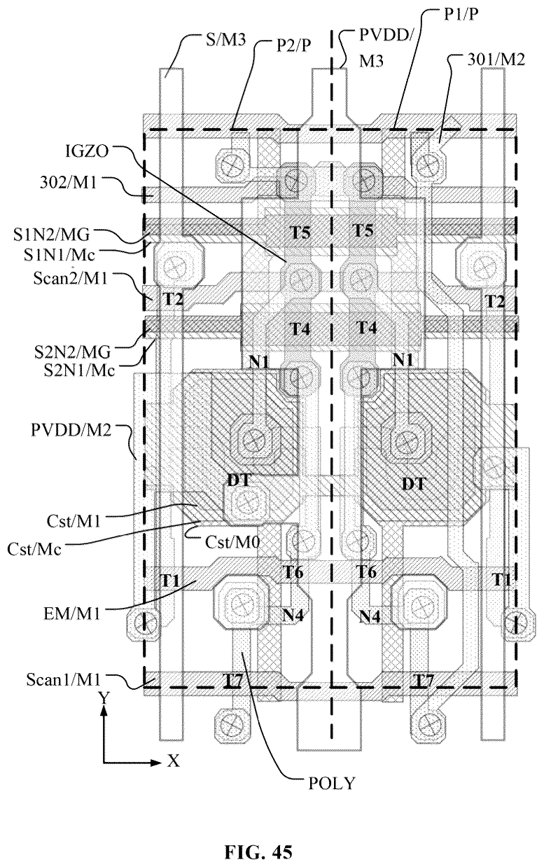

In some optional embodiments, referring to FIGS. 1, 3, 44 and 45, FIG. 44 illustrates another structural schematic of electrical connection of pixel circuits and light-emitting elements of the first color sub-pixel and the second color sub-pixel in the display panel according to various embodiments of the present disclosure; and FIG. 45 illustrates a circuit layout when the pixel circuit structure in FIG. 44 is formed on the substrate of the display panel. It may be understood that, in order to clearly illustrate the structure of one embodiment, transparency filling is performed in FIG. 45, and pattern filling is not performed on the third metal layer M3 in FIG. 45. When above-mentioned exemplary pixel circuit 10 is formed on the substrate 00 included in the display panel 000, the circuit layout is exemplarily shown in FIG. 45. For the pixel circuit shown in FIG. 44 in one embodiment, the fifth transistor T5 and the fourth transistor T4 connected to the gate electrode of the driving transistor DT may respectively be metal oxide transistors with double-gate structures. For example, the fifth transistor T5 and the fourth transistor T4 may both be N-type oxide transistors with double-gate structures, such as N-type IGZO (indium gallium zinc oxide, indium gallium zinc oxide) transistors; and other transistors in the pixel circuit 10 may still be P-type low-temperature polysilicon transistors. The fifth transistor T5 and the fourth transistor T4 may both be double-gate structures, and the active portions of the fifth transistor T5 and the fourth transistor T4 may be indium gallium zinc oxide. The induced charges generated by the potential of two gate electrodes of the double-gate transistor may extend to the active portion of the indium gallium zinc oxide of the double-gate transistor. The active portion of the indium gallium zinc oxide may be at entire region along the thickness direction of the double-gate transistor (due to that two gate electrodes of the double-gate transistor may be overlapped on both the upper surface and the lower surface of the active portion). In such way, the concentration of carrier ions in the fifth transistor T5 and the fourth transistor T4 of the double-gate structure may be increased, which may effectively improve the carrier mobility of the fifth transistor T5 and the fourth transistor T4, thereby being beneficial for further improving the resolution of the display panel. In one embodiment, the pixel circuit 10 may include the double-gate transistor. Higher mobility characteristics of the double-gate transistor may be used to improve the driving capability, such that the pixel circuit 10 may be more suitable for large-size, high-resolution display panel.

The leakage current of the double-gate transistor may be much less than the leakage current of the single-gate transistor. Therefore, the fifth transistor T5 configured to reset the first node N1 may be the double-gate transistor. At the end of the reset stage, after the fifth transistor T5 is turned off to be in disconnection, the potential of the control electrode of the driving transistor DT may remain stable, which may prevent potential decrease of the control electrode of the driving transistor DT from affecting the light-emitting brightness of the light-emitting element 20, thereby being beneficial for improving low-grayscale color cast (deviation). In addition, in one embodiment, the fifth transistor T5 of the pixel circuit 10 may be the N-type oxide transistor with the double-gate structure, such as an N-type IGZO transistor. The transistor may be turned on to be in conduction when both scan signal lines connected to two gate electrodes of above transistor transmit high-level control signals. The high mobility of the double-gate transistor may be used to improve its own driving capability, thereby solving the leakage current problem during low-frequency driving; and high mobility characteristics of the double-gate transistor may also be used to meet the high mobility requirement of current-mode driving apparatus. In one embodiment, the fourth transistor T4 of the pixel circuit 10 may also be the N-type oxide transistor with the double-gate structure, such as an N-type IGZO transistor; and may be turned on to be in conduction when both scan signal lines connected to two gate electrodes of above transistor transmit high-level control signals. During the light-emitting stage, there are two current leakage paths for the gate electrode of the driving transistor DT, where one current leakage path may be through the fifth transistor T5, and another current leakage path may be through the fourth transistor T4. In such way, in one embodiment, the fourth transistor T4 may also be configured to be the N-type oxide transistor with the double-gate structure, and the leakage current of the fourth transistor T4 may be relatively small. Therefore, the current leakage of the driving transistor DT may be effectively reduced, and the potential of the gate electrode of the driving transistor DT may remain stable. In such way, the driving current generated by the driving transistor DT may not change within a relatively large range, which may prevent low-grayscale color cast of the light-emitting element 20 due to insufficient light-emitting and reduce brightness and color cast when the light-emitting element 20 emits light, thereby being beneficial for improving the display effect.

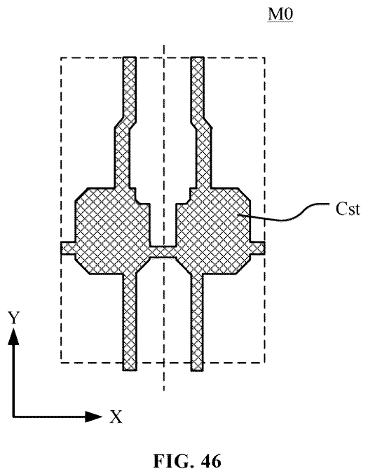

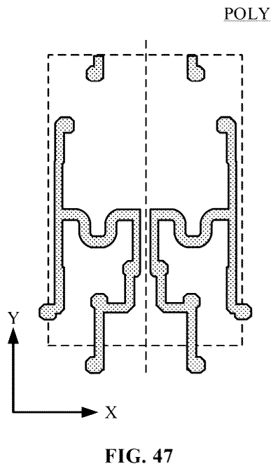

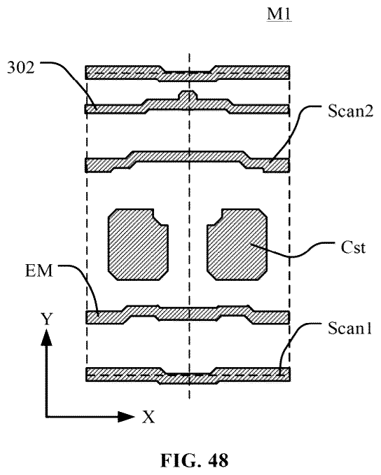

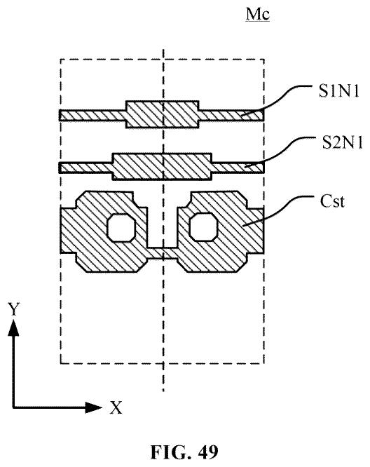

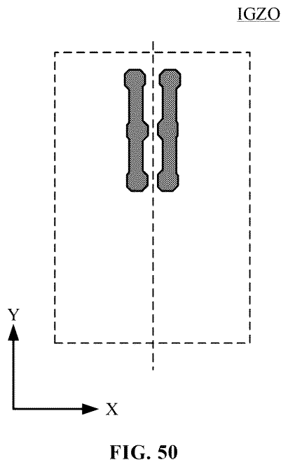

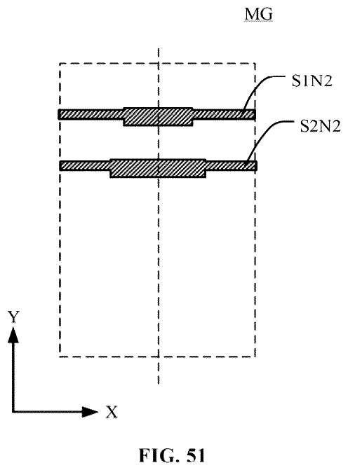

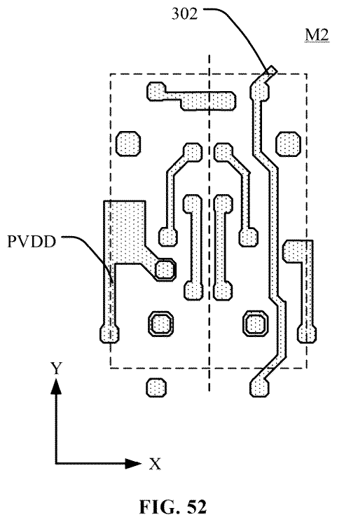

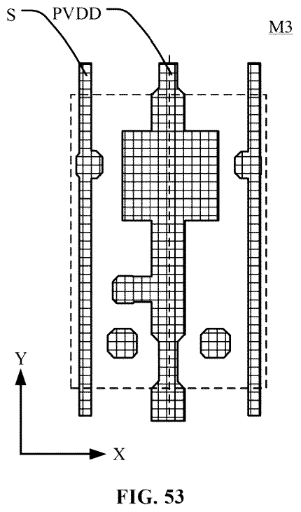

Optionally, when the pixel circuit structure in FIG. 44 is formed on the substrate 00 of the display panel, the circuit layout is exemplarily shown in FIG. 45. The display panel 000 may include the polysilicon semiconductor layer POLY at the side of the substrate 00, the bottom metal layer M0, the first metal layer M1, the capacitor metal layer Mc, the indium gallium zinc oxide semiconductor layer IGZO, the gate metal layer MG, the second Metal layer M2, and the third metal layer M3. Referring to FIGS. 46-53, FIG. 46 illustrates a structural schematic of the polysilicon semiconductor layer in FIG. 44; FIG. 47 illustrates a structural schematic of the bottom metal layer in FIG. 44; FIG. 48 illustrates a structural schematic of the first metal layer in FIG. 44; FIG. 49 illustrates a structural schematic of the capacitor metal layer in FIG. 44; FIG. 50 illustrates a structural schematic of the indium gallium zinc oxide semiconductor layer in FIG. 44; FIG. 51 illustrates a structural schematic of the gate metal layer in FIG. 44; FIG. 52 illustrates a structural schematic of the second metal layer in FIG. 44; and FIG. 53 illustrates a structural schematic of the third metal layer in FIG. 44. The bottom metal layer M0 may be configured to form the plate of the capacitor and overlapped with the capacitor substrate of the first metal layer M1, which may be beneficial for enhancing the coupling performance of the storage capacitor. The polysilicon semiconductor layer POLY may be configured to form the active portion of the low-temperature polysilicon transistor in the pixel circuit 10. The first metal layer M1 may be configured to form the gate electrode of the low-temperature polysilicon transistor in the pixel circuit 10 and the first scan signal line Scan1 and the second scan signal line Scan2 that are electrically connected to the gate electrode of the low-temperature polysilicon transistor in the pixel circuit 10. The first scan signal line Scan1 may be electrically connected to the gate electrode of the seventh transistor T7, and the second scan signal line Scan2 may be electrically connected to the gate electrode of the second transistor T2. Two electrodes of the storage capacitor Cst included in the pixel circuit 10 may be respectively at the first metal layer M1 and the capacitor metal layer Mc. The capacitive metal layer Mc may also be configured to form the gate electrode of the metal oxide transistor in the pixel circuit 10 and the scan signal line electrically connected to such gate electrode. The indium gallium zinc oxide semiconductor layer IGZO may be configured to form the active portions of the metal oxide transistors in the pixel circuit 10, such as the active portions of the fifth transistor T5 and the fourth transistor T4. The gate metal layer MG may be configured to form another gate electrode of the metal oxide transistor in the pixel circuit 10 and the scan signal line electrically connected to another gate electrode. As shown in drawings, the fifth transistor T5 and the fourth transistor T4 may be both N-type metal oxides with the double-gate structures. One gate electrode of the fifth transistor T5 may be at the capacitor metal layer Mc, and another gate electrode of the fifth transistor T5 may be at the gate metal layer MG. One gate electrode of the fifth transistor T5 may be connected to the third scan signal line S1N1 at the capacitor metal layer Mc, and another gate electrode of the fifth transistor T5 may be connected to the fourth scan signal line S1N2 at the gate metal layer MG. The third scan signal line S1N1 and the fourth scan signal line S1N2 may be electrically connected to each other at a non-display region of the display panel 000. One gate electrode of the fourth transistor T4 may be at the capacitor metal layer Mc, and another gate electrode of the fourth transistor T4 may be at the gate metal layer MG. One gate electrode of the fourth transistor T4 may be connected to the fifth scan signal line S2N1 at the capacitor metal layer Mc, and another gate electrode of the fourth transistor T4 may be connected to the sixth scan signal line S2N2 at the gate metal layer MG. The fifth scan signal line S2N1 and the sixth scan signal line S2N2 may be electrically connected to each other at the non-display region of the display panel 000. The source and drain electrodes of the transistors in the pixel circuit may be at the second metal layer M2, and the data line S may be at the third metal layer M3. The first power signal line PVDD may be partially at the second metal layer M2 and partially at the third metal layer M3. FIG. 46-53 are sequentially superimposed to form the layout of the pixel circuit shown in FIG. 45.

In one embodiment, when the electrical connection structure of the pixel circuit 10 and the light-emitting element 20 is configured as shown in FIG. 44-45, the first color sub-pixel P1 and the second color sub-pixel P2 may be disposed to be adjacent to each other. The display panel 000 may at least include the first reference voltage signal line 301 and the second reference voltage signal line 302. The first reference voltage signal line 301 may be electrically connected to the anode of the light-emitting element 20 in the first color sub-pixel P1 (the fourth node N4 of the pixel circuit 10 of the first color sub-pixel P1). The second reference voltage signal line 302 may be not only electrically connected to the anode of the light-emitting element 20 in the second color sub-pixel P2 (the fourth node N4 of the pixel circuit 10 of the second color sub-pixel P2), and may also be electrically connected to the gate electrodes of the driving transistors DT in the first color sub-pixel P1 and the second color sub-pixel P2 (the first nodes N1 of the first color sub-pixel P1 and the second color sub-pixel P2 of the pixel circuit 10), such that the first reference voltage signal line 301 may only need to be electrically connected to the fourth node N4 in the pixel circuit 10 of the first color sub-pixel P1. Therefore, the number of reference voltage signal lines in the panel may be further reduced to provide more space for the layout of the pixel circuit 10, which may avoid mutual interference problem caused by a large number of signal lines which are excessively adjacent to each other, thereby being beneficial for further improving the display quality. The potential of the fourth node N4 of the first color sub-pixel P1 may be independently pulled down through the first reference voltage signal line 301, that is, the voltage value of an initial reference signal at the anode of the light-emitting element 20 of the first color sub-pixel P1 may be independently pulled down. Even if the first color sub-pixel P1 is affected by the common film layer to charge the anode of the light-emitting element 20 when the second color sub-pixel P2 is turned on to achieve the monochrome picture, longer charging time and more charges may be needed to reach the target turn-on voltage for the first color sub-pixel P1; and the light-emitting element 20 of the first color sub-pixel P1 may be less likely to be turned on. Therefore, the undesired display problem of the first color sub-pixel P1 when the monochrome picture of the second color sub-pixel P2 is turned on may be effectively reduced, which may be beneficial for improving the display quality.

Optionally, in one embodiment, as shown in FIG. 45, the extension directions of the first reference voltage signal line 301 and the second reference voltage signal line 302 may intersect to each other; the first reference voltage signal line 301 and the second reference voltage signal line 302 may be disposed at different layers; the first reference voltage signal line 301 may extend along the second direction Y and may be at the second metal layer M2; and the second reference voltage signal line 302 may extend along the first direction X and may be at the first metal layer M1. During an implementation manner, other arrangement manners may be selected for the extension directions and film layer arrangements of the first reference voltage signal line 301 and the second reference voltage signal line 302; and FIG. 45 may be only exemplary for illustration in one embodiment.

Optionally, as shown in FIGS. 45-53, in one embodiment, in the plurality of sub-pixels P of the display panel 000, the pixel circuits 10 of at least two adjacent sub-pixels P may have a mirror-symmetric structure. Furthermore, optionally, along the first direction X, the pixel circuits of at least two adjacent sub-pixels may have a mirror-symmetric structure. In drawings of one embodiment, the pixel circuit 10 of the first color sub-pixel P1 and the pixel circuit 10 of the second color sub-pixel P2 may be at a same row, which is taken an example for illustration.

The display panel 000 may include a plurality of power signal lines. The power signal lines may be first power signal lines PVDD; and at least a part of the first power signal lines PVDD may extend along the second direction Y. Two pixel circuits 10 in a mirror-symmetric structure may share one first power supply signal line PVDD extending along the second direction Y.

In one embodiment, it describes that the pixel circuit 10 of the first color sub-pixel P1 and the pixel circuit 10 of the second color sub-pixel P2 in a same row may be configured to be mirror symmetrical; and the pixel circuit 10 of first color sub-pixel P1 and the pixel circuit 10 of the second color sub-pixel P2 which are mirror symmetrical may share one first power supply signal line PVDD, which may be beneficial for reducing the number of power signal lines and saving the layout space of the power signal lines. Furthermore, while the pixel arrangement density is increased, the width of the same first power signal line PVDD, connected to the pixel circuit 10 of the first color sub-pixel P1 and the pixel circuit 10 of the second color sub-pixel P2 which are mirror symmetrical, may also be wider, which may be beneficial for further reducing the impedance of the first power signal line PVDD and desirably ensuring the display quality.

It may be understood that in one embodiment, the width of the first power supply signal line PVDD shared by the pixel circuit 10 of the first color sub-pixel P1 and the pixel circuit 10 of the second color sub-pixel P2 may not be limited. As the layout space allows, the width of the first power signal line PVDD may be designed to be as wide as possible to desirably reduce impedance and ensure display quality.

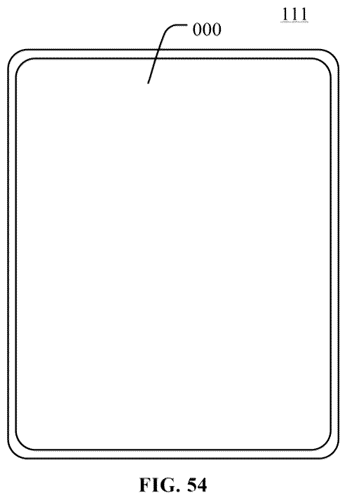

In some optional embodiments, referring to FIG. 54, FIG. 54 illustrates a planar structural schematic of a display apparatus according to various embodiments of the present disclosure. A display apparatus 111 provided in one embodiment may include the display panel 000 provided in above-mentioned embodiment of the present disclosure. In one embodiment, a mobile phone may be taken as an example to illustrate the display apparatus 111 in FIG. 54. It may be understood that the display apparatus 111 provided by embodiments of the present disclosure may be a computer, a television, a vehicle-mounted display apparatus, or other display apparatus 111 with a display function, which may not be limited in the present disclosure. The display apparatus 111 provided by embodiments of the present disclosure may have the beneficial effects of the display panel 000 provided by embodiments of the present disclosure, which may refer to specific description of the display panel 000 in above-mentioned embodiments and may not be described in detail in embodiments of the present disclosure.

It may be seen from above-mentioned embodiments that the display panel and the display apparatus provided by the present disclosure may at least achieve the following beneficial effects.

The display panel provided by the present disclosure may include the plurality of sub-pixels with different colors, and the sub-pixels may drive the light-emitting elements included in the sub-pixels to achieve light-emitting display function through the pixel circuits included in the sub-pixels. The display panel may at least include the first reference voltage signal line and the second reference voltage signal line. In the plurality of sub-pixels, the first reference voltage signal line may be electrically connected to the anode of the light-emitting element in the first color sub-pixel, and the reference signal transmitted on the first reference voltage signal line may be configured to reset the anode of the light-emitting element in the first color sub-pixel; and the second reference voltage signal line may be electrically connected to the anode of the light-emitting element in the second color sub-pixel, and the reference signal transmitted on the second reference voltage signal line may be configured to reset the anode of the light-emitting element in the second color sub-pixel. Furthermore, in the present disclosure, it also configures that if the turn-on voltage of the light-emitting element of the first color sub-pixel is different from the turn-on voltage of the light-emitting element of the second color sub-pixel, the voltage value of the reference signal transmitted on the first reference voltage signal line for resetting the anode of the first color sub-pixel light-emitting element may be also different from the voltage value of the reference signal transmitted on the second reference voltage signal line for resetting the anode of the second color sub-pixel light-emitting element. That is, when one sub-pixel in the second color sub-pixel and the first color sub-pixel is turned on to achieve the monochrome picture, even if another sub-pixel in the second color sub-pixel and the first color sub-pixel without being inputted with the turn-on voltage is affected by the common film layer to charge the anode of corresponding light-emitting element, longer charging time and more charges may be needed to reach the target turn-on voltage of the sub-pixel which has been turned on; and the light-emitting element of another sub-pixel in the second color sub-pixel and the first color sub-pixel may be less likely to be turned on. Therefore, the undesired display problem of adjacent sub-pixels of different colors when the monochrome picture is turned on may be effectively reduced, which may be beneficial for improving the display quality. Furthermore, the material with higher carrier mobility may be used to form the common film layer in the display panel, and the power consumption of the display panel may not increase significantly.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A display panel, comprising:
a plurality of sub-pixels of different colors, wherein a sub-pixel of the plurality of sub-pixels of different colors includes a pixel circuit and a light-emitting element which are electrically connected to each other, and the plurality of sub-pixels of different colors at least includes a first color sub-pixel and a second color sub-pixel, wherein:
the display panel at least includes a first reference voltage signal line and a second reference voltage signal line;
in the plurality of sub-pixels of different colors, the first reference voltage signal line is electrically connected to an anode of a light-emitting element in the first color sub-pixel; and the second reference voltage signal line is electrically connected to an anode of a light-emitting element in the second color sub-pixel; and
a voltage value of a reference signal transmitted on the first reference voltage signal line is different from a voltage value of a reference signal transmitted on the second reference voltage signal line.

2. The display panel according to claim 1, wherein:
a turn-on voltage of the light-emitting element in the first color sub-pixel is less than a turn-on voltage of the light-emitting element in the second color sub-pixel; and the voltage value of the reference signal transmitted on the first reference voltage signal line is less than the voltage value of the reference signal transmitted on the second reference voltage signal line.

3. The display panel according to claim 1, wherein:
an extension direction of the first reference voltage signal line is same as an extension direction of the second reference voltage signal line.

4. The display panel according to claim 1, wherein:
the first reference voltage signal line extends along a first direction, and the second reference voltage signal line extends along a second direction, wherein the first direction intersects the second direction.

5. The display panel according to claim 4, wherein:
along the first direction, a width of a pixel circuit of the first color sub-pixel is less than a width of a pixel circuit of the second color sub-pixel.

6. The display panel according to claim 1, wherein:
the first color sub-pixel includes a red sub-pixel or a green sub-pixel; and the second color sub-pixel includes a blue sub-pixel.

7. The display panel according to claim 1, further including:
a data line, wherein the pixel circuit includes a storage capacitor; the first reference voltage signal line is disposed at a same layer as an electrode of the storage capacitor; and the second reference voltage signal line is disposed at a same layer as the data line.

8. The display panel according to claim 1, wherein:
the pixel circuit at least includes a driving transistor; and
the first reference voltage signal line is electrically connected to a gate electrode of a driving transistor in the first color sub-pixel, and the second reference voltage signal line is electrically connected to a gate electrode of a driving transistor in the second color sub-pixel.

9. The display panel according to claim 1, wherein:
the pixel circuit at least includes a driving transistor; and
the first reference voltage signal line is electrically connected to a gate electrode of a driving transistor in the first color sub-pixel and electrically connected to a gate electrode of a driving transistor in the second color sub-pixel.

10. The display panel according to claim 1, wherein:
the pixel circuit at least includes a driving transistor; and
the second reference voltage signal line is electrically connected to a gate electrode of a driving transistor in the first color sub-pixel and electrically connected to a gate electrode of a driving transistor in the second color sub-pixel.

11. The display panel according to claim 1, further including:
a third reference voltage signal line; wherein:
the pixel circuit at least includes a driving transistor; and
the third reference voltage signal line is electrically connected to a gate electrode of a driving transistor in the first color sub-pixel and electrically connected to a gate electrode of a driving transistor in the second color sub-pixel.

12. The display panel according to claim 11, wherein:
a voltage value of a reference signal transmitted on the third reference voltage signal line is greater than each of the voltage value of the reference signal transmitted on the first reference voltage signal line and the voltage value of the reference signal transmitted on the second reference voltage signal line.

13. The display panel according to claim 11, wherein:
an extension direction of the third reference voltage signal line is same as an extension direction of the first reference voltage signal line, and an extension direction of the second reference voltage signal line intersects the extension direction of the first reference voltage signal line; or
an extension direction of the third reference voltage signal line intersects an extension direction of the first reference voltage signal line, and an extension direction of the second reference voltage signal line is same as the extension direction of the first reference voltage signal line.

14. The display panel according to claim 13, wherein:
a voltage value of a reference signal transmitted on the third reference voltage signal line is equal to the voltage value of the reference signal transmitted on the second reference voltage signal line.

15. The display panel according to claim 14, wherein:
the third reference voltage signal line and the second reference voltage signal line are connected to each other to form a grid structure.

16. The display panel according to claim 1, wherein:
the plurality of sub-pixels of different colors further includes a third color sub-pixel; and the first color sub-pixel is a red sub-pixel, the second color sub-pixel is a blue sub-pixel, and the third color sub-pixel is a green sub-pixel;
the display panel further includes a fourth reference voltage signal line, electrically connected to an anode of a light-emitting element of the third color sub-pixel; and
the voltage value of the reference signal transmitted on the first reference voltage signal line is less than a voltage value of a reference signal transmitted on the fourth reference voltage signal line; and the voltage value of the reference signal transmitted on the fourth reference voltage signal line is less than the voltage value of the reference signal transmitted on the second reference voltage signal line.

17. The display panel according to claim 16, wherein:
an extension direction of the fourth reference voltage signal line is same as an extension direction of the first reference voltage signal line and intersects an extension direction of the second reference voltage signal line.

18. The display panel according to claim 1, wherein:
in the plurality of sub-pixels of different colors of the display panel, pixel circuits of at least two adjacent sub-pixels form a mirror-symmetric structure.

19. The display panel according to claim 18, wherein:
along a first direction, pixel circuits of at least two adjacent sub-pixels form a mirror-symmetric structure; and
the display panel includes a plurality of power signal lines, wherein at least a part of the plurality of power signal lines extends along a second direction; the first direction intersects the second direction; and two pixel circuits of the mirror-symmetric structure share a power signal line extending along the second direction.

20. A display apparatus, comprising:
a display panel, comprising:
a plurality of sub-pixels of different colors, wherein a sub-pixel of the plurality of sub-pixels of different colors includes a pixel circuit and a light-emitting element which are electrically connected to each other, and the plurality of sub-pixels of different colors at least includes a first color sub-pixel and a second color sub-pixel, wherein:
the display panel at least includes a first reference voltage signal line and a second reference voltage signal line;
in the plurality of sub-pixels of different colors, the first reference voltage signal line is electrically connected to an anode of a light-emitting element in the first color sub-pixel; and the second reference voltage signal line is electrically connected to an anode of a light-emitting element in the second color sub-pixel; and
a voltage value of a reference signal transmitted on the first reference voltage signal line is different from a voltage value of a reference signal transmitted on the second reference voltage signal line.
